(19) United States
(12) Patent Application Publication
(10) Pub. No.: US 2025/0237991 A1
(43) Pub. Date: Jul. 24, 2025

(54) DRUM UNIT AND PROCESSING CARTRIDGE

(71) Applicant: Zhuhai Ninestar Information Technology Co. , Ltd, Zhuhai (CN)

(72) Inventors: Qin LUO, Zhuhai (CN); Yinghao LI, Zhuhai (CN); Hao DENG, Zhuhai (CN); Roujuan CHEN, Zhuhai (CN); Mingdong CHEN, Zhuhai (CN)

(21) Appl. No.: 19/097,595

(22) Filed: Apr. 1, 2025

Related U.S. Application Data
(63) Continuation of application No. PCT/CN2023/124784, filed on Oct. 16, 2023.

(30) Foreign Application Priority Data
Oct. 14, 2022 (CN) 202222734532.0
Oct. 17, 2022 (CN) 202222736184.0
Nov. 28, 2022 (CN) 202223165932.0
Nov. 28, 2022 (CN) 202223167230.6
Dec. 6, 2022 (CN) 202223262339.8

(51) Int. Cl. G03G 15/00; G03G 21/16; G03G 21/18

(52) U.S. Cl. CPC G03G 15/757; G03G 21/1647; G03G 21/1814; G03G 21/1817; G03G 21/186; G03G 2221/1606

(57) ABSTRACT

A drum unit, detachably installed in a main assembly of an image forming device, includes a photosensitive drum and a coupling. The main assembly includes a drum drive transmission unit that includes a driving force transmission member, a first braking force engagement member, and a second braking force engagement member. The first and second braking force engagement members are disposed in the driving force transmission member. The driving force transmission member includes a cylindrical part, a driving force transmission part and a positioning boss. The coupling is coaxially disposed at one end of the photosensitive drum, and includes a middle accommodation member and a sleeve. The sleeve is provided with a driving force accommodation member, where the driving force accommodation member is able to be engaged with the driving force transmission member to transmit power received from the driving force transmission member to the photosensitive drum.

### CROSS-REFERENCE TO RELATED APPLICATION

This application is a continuation application of International Patent Application No. PCT/CN2023/124784, filed Oct. 16, 2023, which claims the priority of Chinese Patent Application No. 202222734532.0, filed on Oct. 14, 2022, the priority of Chinese Patent Application No. 202222736184.0, filed on Oct. 17, 2022, the priority of Chinese Patent Application No. 202223167230.6, filed on Nov. 28, 2022, the priority of Chinese Patent Application No. 202223165932.0, filed on Nov. 28, 2022, and the priority of Chinese Patent Application No. 202223262339.8, filed on Dec. 6, 2022, the contents of all of which are incorporated herein by reference in their entirety.

### TECHNICAL FIELD

The present disclosure relates to the field of image forming technologies and, more particularly, relates to a drum unit and a processing cartridge.

### BACKGROUND

In the field of electronic photographic image forming devices, an electronic photographic photosensitive member (e.g., a photosensitive drum) and a processing device acting on the photosensitive drum are integrated to form a cartridge (usually referred to as a processing cartridge). The processing cartridge can be disassembled from a main assembly of the image forming device.

A drum drive transmission unit disclosed in Chinese patent CN113574469A, is engaged with a driving force receiving unit (i.e., a coupling) on the processing cartridge through multiple components for driving and braking. As shown in FIG. 1, an electrophotographic image forming apparatus M includes a main assembly 170, a tray 171 and a door cover 11. The main assembly 170 is provided with an accommodating portion, a drum drive transmission unit 203, a separation mechanism, and a transfer unit, etc. The tray 171 can accommodate the processing cartridge 100 and is movable relative to the main assembly 170 for mounting the processing cartridge 100 within the accommodating portion of the main assembly 170. The door cover 11 is arranged on the outside of the main assembly 170, and can open or close the accommodating portion of the main assembly 170.

As shown in FIG. 2 to FIG. 7, the drum drive transmission unit 203 arranged on the main assembly 170 includes a driving force transmission component and a braking force applying component. The driving force transmission component includes a first rotating member 201 and a driving force transmission member 180. The first rotating member 201 is rotatably supported on a support shaft 202. One end of the driving force transmission member 180 is provided with a rotation stop portion 180b for receiving the driving force, and the other end is provided with a driving force transmission portion 180v. The driving force transmission member 180 is assembled on the first rotating member 201 in a manner movable along the axial direction M1, and the first rotating member 201 drives the driving force transmission member 180 to rotate through the cooperation between the rotation stop portion 201b provided on the first rotating member 201 and the rotation stop portion 180b provided on the driving force transmission member 180.

The braking force applying assembly includes a braking member 206, a first braking force engaging member 204, a second braking force engaging member 208, a first engaging spring 211, a second spring 210 and a braking transmission member 207. The braking member 206 includes a fixed side 206a and a rotating side 206b. The fixed side 206a is fixedly connected to the support shaft 202, and the rotating side 206b is capable of rotating relative to the fixed side 206a and generating a braking force. A method for generating the braking force can be appropriately selected from methods using friction or viscosity.

The first braking force engaging member 204 and the second braking force engaging member 208 are used to apply braking force to the processing cartridge 100, and are assembled together by engaging the rotation stop protrusion 208c and the rotation stop recess 204c to have a synchronous action process. The second braking force engaging member 208 is located on the inner side of the first braking force engaging member 204, and the engaging portion 204b of the first braking force engaging member 204 is in contact with the vertical surface 180x2 or abut against each other.

The shaft portion 207b of the brake force transmission member 207 passes through the through hole in the middle of the first braking force engaging member 204 and the second braking force engaging member 208, and is connected to the rotating side 206b of the brake member 206, to be able to transmit the braking force to the first braking force engaging member 204 and the second braking force engaging member 208.

The flange portion 207a of the brake force transmission member 207 is provided with a protrusion 207e, and the corresponding flange portion 204a of the first brake force engagement member 204 is provided with a protrusion 204e. When the protrusion 207e of the brake force transmission member 207 is engaged with the protrusion 204e of the first brake force engagement member 204, the brake force transmission member 207 can transfer the braking force to the first brake force engagement member 204.

The first brake force engagement member 204 and the second brake force engagement member 208 can move relative to the brake force transmission member 207 and the brake member 206 in the axial direction M1. When the protrusion 207e of the brake force transmission member 207 is offset or separated from the protrusion 204e of the first brake force engagement member 204 in the axial direction M1, the second brake force engagement member 208 and the first brake force engagement member 204 will not receive the braking force.

As shown in FIG. 4 and FIG. 5, one end of the first engagement spring 211 is pressed against the end face 206d of the brake member 206, and the other end is pressed against the flange portion 204a of the first braking force engagement member 204. The first engagement spring 211 is in a compressed state, and applies an elastic force to the first braking force engagement member 204 in the M1B direction. The elastic force can keep the protrusion 207e of the brake force transmission member 207 engaged with the protrusion 204e of the first braking force engagement member 204.

The second spring 210 is a compression coil spring, and is provided to be sandwiched and compressed between the end face 206d of the brake member 206 and the flange portion 207a of the brake force transmission member 20. The second spring 210 applies a repulsive force (pushing force, elastic force) to each of the end face 206d of the brake member 206 and the flange portion 207a of the brake force transmission member 207.

Among the components of the drum drive transmission unit 203, under the action of the first engagement spring 211 and the second spring 210, the protrusion 207f at the end of the brake force transmission member 207 in the axial direction M1A abuts against the contact surface 180f of the driving force transmission member 180. The movement of the driving force transmission member 180 in the arrow M1B direction is regulated (restricted) by the axial direction restriction portion 212, such that the driving force transmission member 180 does not fall off from the side drum drive transmission unit 203 of the main assembly 170.

Among the components of the drum drive transmission unit 203, the driving force transmission member 180 is movable in the M1A and M1B directions relative to the first rotating member 201. The first braking force engagement member 204 and the second braking force engagement member 208 are movable in the M1A and M1B directions relative to the brake force transmission member 207 and the first rotating member 201, and are also movable in the M1A and M1B directions relative to the driving force transmission member 180.

As shown in FIG. 2, FIG. 6 and FIG. 7, the driving force transmission member 180 includes a cylindrical portion 180c, a driving force transmission part 180v and a positioning boss 180i. The cylindrical portion 180c has an inner abutment surface 180cl facing the M1B direction around the positioning boss 180i.

The first braking force engaging member 204 has two engaging portions 204b protruding in the form of claws toward the direction of the processing box and engaging with the coupling. The second braking force engaging member 208 has two engaging portions 208b protruding in the form of claws toward the direction of the processing box and engaging with the coupling. The driving force transmission part 180v is provided with an inclined surface 180x1 and a vertical surface 180x2 on the side of the engaging portion 204b close to the first braking force engaging member 204, and a vertical surface 180x3 is provided on the side facing away from the engaging portion 204b.

The transmission mode of the existing photosensitive drum is relatively complicated, the engagement is not stable enough, and is easy to disengage, resulting in unstable power transmission.

### SUMMARY

One aspect of the present disclosure provides a drum unit. The drum unit includes a photosensitive drum and a coupling. The drum unit is used to be detachably installed in a main assembly of an image forming device. The main assembly includes a drum drive transmission unit. The drum drive transmission unit includes a driving force transmission member, a first braking force engagement member, and a second braking force engagement member. The first braking force engagement member and the second braking force engagement member are disposed in the driving force transmission member. The driving force transmission member includes a cylindrical part, a driving force transmission part and a positioning boss. The coupling is coaxially disposed at one end of the photosensitive drum, and includes a middle accommodation member and a sleeve. The sleeve is provided with a driving force accommodation member, where the driving force accommodation member is able to be engaged with the driving force transmission member to transmit power received from the driving force transmission member to the photosensitive drum.

Another aspect of the present disclosure provides a drum unit including a photosensitive drum and a coupling. The drum unit is used to be detachably installed in a main assembly of an image forming device. The main assembly includes a drum drive transmission unit. The drum drive transmission unit includes a driving force transmission member, a first braking force engagement member, and a second braking force engagement member. The first braking force engagement member and the second braking force engagement member are disposed in the driving force transmission member. The driving force transmission member includes a cylindrical part, a driving force transmission part and a positioning boss. The coupling is coaxially arranged at one end of the photosensitive drum; and the coupling includes a middle accommodation member. The middle accommodation member is able to be engaged with the driving force transmission member to transmit power received from the driving force transmission member to the photosensitive drum.

Another aspect of the present disclosure provides a processing cartridge used to be detachably installed in a main assembly of an image forming device, including a developing unit, a drum unit, and a coupling. The main assembly includes a drum drive transmission unit and a developing driving transmission unit. The drum drive transmission unit includes a driving force transmission member, a first braking force engagement member, and a second braking force engagement member. The first braking force engagement member and the second braking force engagement member are disposed in the driving force transmission member. The developing unit includes a developing frame, a developing roller, and a developing driving force receiving unit. The drum unit includes a photosensitive frame and a photosensitive drum. The coupling is coaxially arranged at an end of the photosensitive drum. The coupling is able to be engaged with the drum drive transmission unit to receive a driving force; and the developing driving force receiving unit is used to engage with the developing driving force transmission unit to receive a driving force, to drive the developing roller and the photosensitive drum to rotate.

### BRIEF DESCRIPTION OF THE DRAWINGS

The following drawings are merely examples for illustrative purposes according to various disclosed embodiments and are not intended to limit the scope of the present disclosure.

FIG. 1 illustrates a structural schematic diagram of an image forming device.

FIG. 2 illustrates a decomposition schematic of a drum driving transmission unit of image forming device.

FIG. 3 illustrates a structural schematic diagram of a first brake force engagement member and a brake force transmission member.

FIG. 4 illustrates a sectional view of a drum drive transmission unit.

FIG. 5 illustrates a sectional perspective view of a drum drive transmission unit.

FIG. 6 illustrates a structural schematic diagram of a drum drive transmission unit.

FIG. 7 illustrates a structural schematic diagram of a drum drive transmission member.

FIG. 8 illustrates a structural schematic diagram of an exemplary processing cartridge according to various disclosed embodiments of the present disclosure.

FIG. 9 illustrates a schematic diagram of an overall structure of an exemplary processing cartridge at one angle according to various disclosed embodiments of the present disclosure.

FIG. 10 illustrates a schematic diagram of a structure of another developer transmission component according to various disclosed embodiments of the present disclosure.

FIG. 11 illustrates a decomposition diagram of a coupling, a photosensitive drum, and a driving force transmission member connected to them according to various disclosed embodiments of the present disclosure.

FIG. 12 illustrates a sectional view of a coupling, a photosensitive drum, and a driving force transmission member connected to them according to various disclosed embodiments of the present disclosure.

FIG. 13 illustrates a schematic diagram of the structure of a coupling, a photosensitive drum, and a driving force transmission member connected to them according to various disclosed embodiments of the present disclosure.

FIG. 14 illustrates a sectional view of a coupling, a photosensitive drum, and a driving force transmission member connected to them according to various disclosed embodiments of the present disclosure.

FIG. 15 illustrates a structural schematic diagram of a processing cartridge at one angle according to various disclosed embodiments of the present disclosure.

FIG. 16 illustrates a partial structural diagram of a photosensitive drum and a coupling according to various disclosed embodiments of the present disclosure.

FIG. 17 illustrates a partial structural sectional view of a photosensitive drum and a coupling according to various disclosed embodiments of the present disclosure.

FIG. 18 illustrates partial schematic structural diagram of a coupling according to various disclosed embodiments of the present disclosure.

FIG. 19 illustrates a partial structural diagram of a photosensitive drum and a coupling according to various disclosed embodiments of the present disclosure.

FIG. 20 illustrates a partial structural diagram of a photosensitive drum and a coupling according to various disclosed embodiments of the present disclosure.

FIG. 21 illustrates a partial structural sectional view of a photosensitive drum and a coupling according to various disclosed embodiments of the present disclosure.

FIG. 22 illustrates a decomposition diagram a partial view of a photosensitive drum and a coupling according to various disclosed embodiments of the present disclosure.

FIG. 23 illustrates a partial structural sectional view of a photosensitive drum and a coupling according to various disclosed embodiments of the present disclosure.

FIG. 24 illustrates a partial structure diagram of a photosensitive drum and a coupling according to various disclosed embodiments of the present disclosure.

FIG. 25 illustrates a partial structure diagram of a photosensitive drum and a coupling according to various disclosed embodiments of the present disclosure.

FIG. 26 illustrates a structural schematic diagram of a sleeve according to various disclosed embodiments of the present disclosure.

FIG. 27 illustrates a partial schematic sectional view of a photosensitive drum and a coupling according to various disclosed embodiments of the present disclosure.

FIG. 28 illustrates a structural schematic diagram of a rotating member according to various disclosed embodiments of the present disclosure.

FIG. 29 illustrates a partially enlarged view of a coupling according to various disclosed embodiments of the present disclosure.

FIG. 30 illustrates a decomposition schematic of a processing cartridge from one angle according to various disclosed embodiments of the present disclosure.

FIG. 31 illustrates a decomposition schematic of a processing cartridge from another angle according to various disclosed embodiments of the present disclosure.

FIG. 32 illustrates a sectional view of a coupling of a processing cartridge according to various disclosed embodiments of the present disclosure.

FIG. 33 illustrates a structural schematic diagram of a processing cartridge in a drum-roller contact state according to various disclosed embodiments of the present disclosure.

FIG. 34 illustrates a structural schematic diagram of a processing cartridge in a drum-roller separation state according to various disclosed embodiments of the present disclosure.

FIG. 35 illustrates a structural schematic diagram of a gear state at a drive end in FIG. 37 according to various disclosed embodiments of the present disclosure.

FIG. 36 illustrates a schematic diagram of an overall structure of a processing cartridge after removal of a protective cover and a drive side end cover; according to various disclosed embodiments of the present disclosure.

FIG. 37 illustrates a structural schematic diagram of a coupling and a photosensitive drum, and a drive force transmission member connected thereto according to various disclosed embodiments of the present disclosure.

FIG. 38 illustrates a sectional view of a coupling and a photosensitive drum, and a drive force transmission member connected thereto according to various disclosed embodiments of the present disclosure.

FIG. 39 illustrates a decomposition schematic of a processing cartridge according to various disclosed embodiments of the present disclosure.

FIG. 40 illustrates a structural schematic diagram of a processing cartridge in a drum-roller contact state according to various disclosed embodiments of the present disclosure.

FIG. 41 illustrates a structural schematic diagram of a processing cartridge in a drum-roller separation state according to various disclosed embodiments of the present disclosure.

FIG. 42 illustrates a structural schematic diagram of a processing cartridge according to various disclosed embodiments of the present disclosure.

FIG. 43 illustrates a structural schematic diagram of a processing cartridge according to various disclosed embodiments of the present disclosure.

FIG. 44 illustrates a sectional view of a coupling of a processing cartridge according to various disclosed embodiments of the present disclosure.

FIG. 45 illustrates a structural schematic diagram of the structure of a drive side end cover and a moving member when assembled according to various disclosed embodiments of the present disclosure.

FIG. 46 illustrates a structural schematic diagram of the structure of a support member and a connection member when assembled according to various disclosed embodiments of the present disclosure.

FIG. 47 illustrates a structural schematic diagram of a processing cartridge in a drum-roller contact state according to various disclosed embodiments of the present disclosure.

FIG. 48 illustrates a structural schematic diagram of a processing cartridge in a drum-roller separation state according to various disclosed embodiments of the present disclosure.

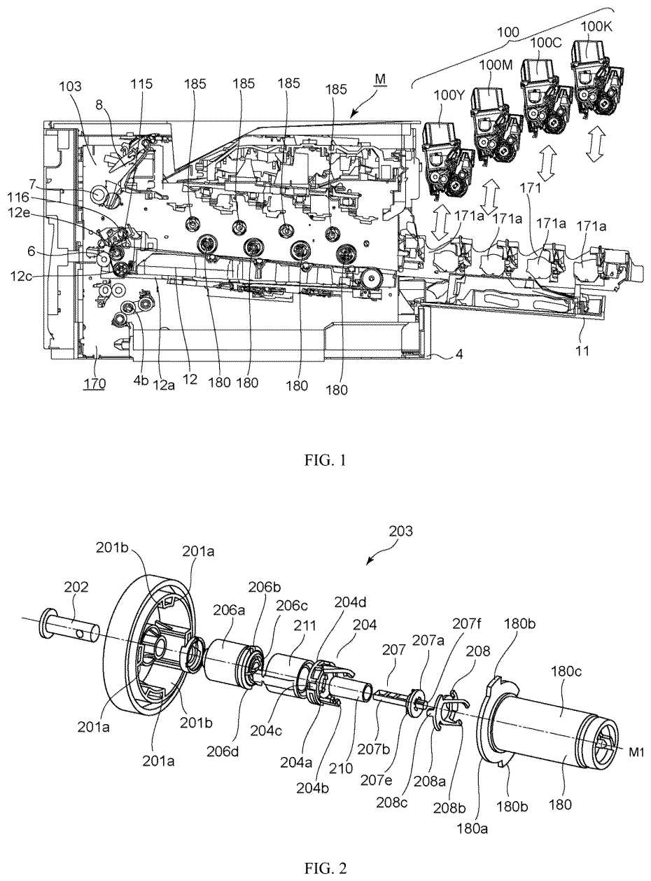

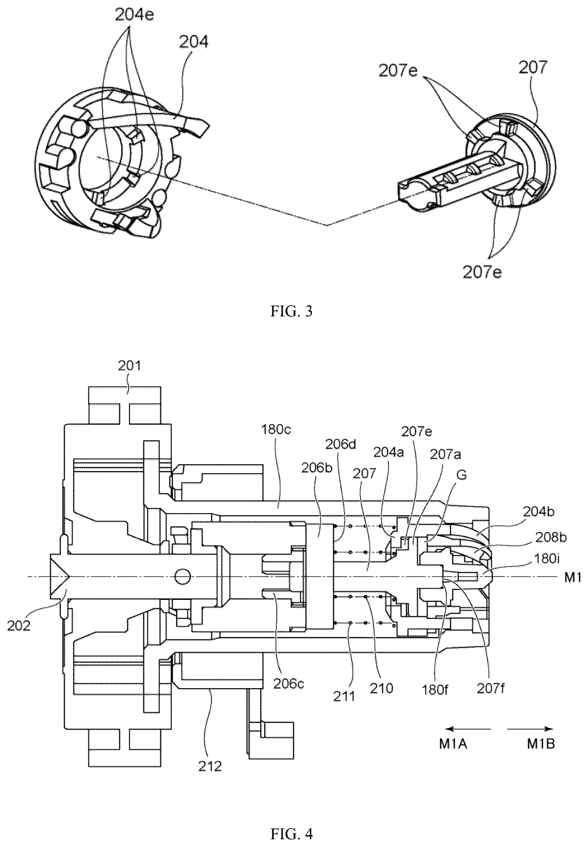

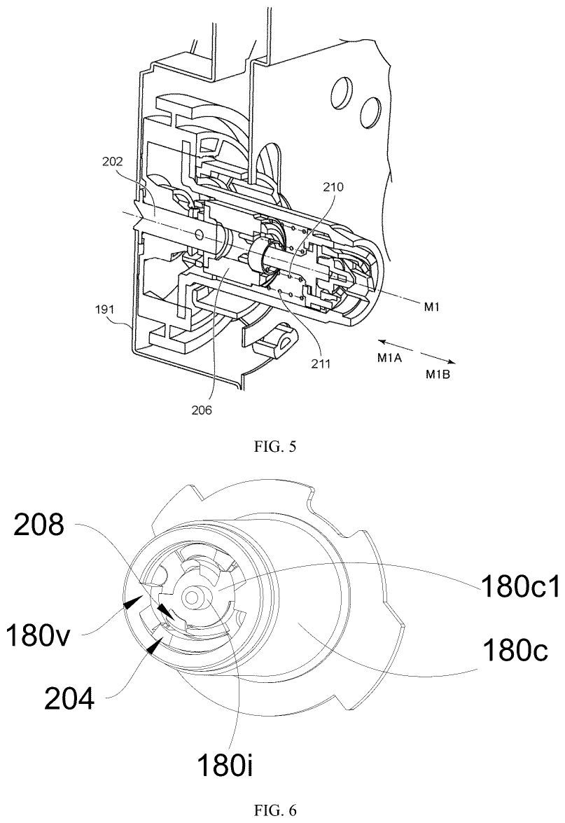

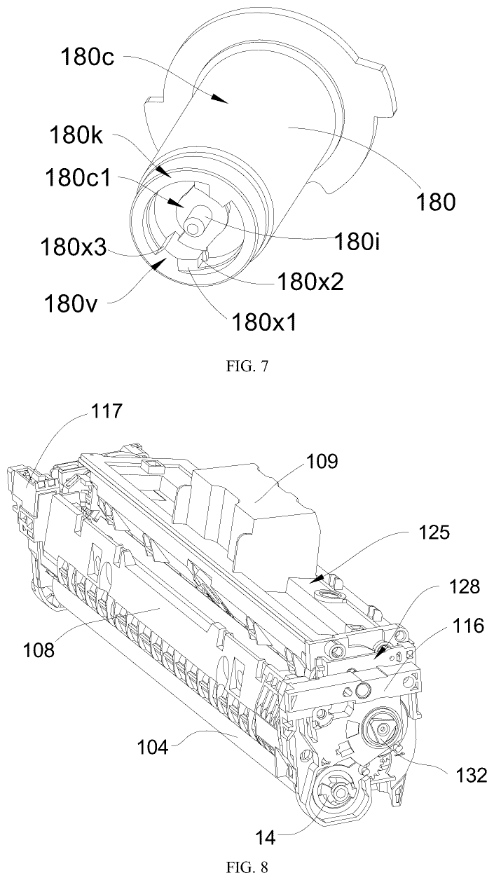

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts. The embodiments disclosed herein are exemplary only. Other applications, advantages, alternations, modifications, or equivalents to the disclosed embodiments are obvious to those skilled in the art and are intended to be encompassed within the scope of the present disclosure.

It should be noted that the terms used in the embodiments of the present disclosure are only for the purpose of describing specific embodiments, and are not intended to limit the scope of the present disclosure. As used in the embodiments of the present disclosure and the appended claims, the singular forms such as “a”, “said” and “the” are also intended to include the plural forms unless the context clearly indicates otherwise.

It should be understood that the term “and/of” used in this specification is just for relationship description of related objects, indicating that there can be three kinds of relationships. For example, A and/or B, which can mean that A exists alone, A and B exist at the same time, and B exists alone. In addition, the character “/” in this specification generally indicates that the related objects are in an “of” relationship.

The terms “first”, “second”, etc. are used for descriptive purposes only and cannot be understood as indicating or implying relative importance or implicitly indicating the number of technical features indicated. Therefore, the features defined as “first” and “second” may explicitly or implicitly include at least one of the features. In the description of the present disclosure, the meaning of “multiple” is at least two, such as two, three, etc., unless otherwise clearly defined.

In the present disclosure, unless otherwise clearly defined, the terms “installed”, “connected”, “fixed”, etc. should be understood in a broad sense, for example, it can be a fixed connection, a detachable connection, or an integral body; it can be a mechanical connection; it can be directly connected, or indirectly connected through an intermediate medium, it can be the internal connection of two elements or the interaction relationship between two elements, unless otherwise clearly defined. For those skilled in the art, the specific meanings of the above terms in the present disclosure can be understood according to the specific circumstances.

In the present disclosure, unless otherwise clearly defined, the first feature “on” or “under” the second feature can be the first and second features directly contacting, or the first and second features indirectly contacting through an intermediate medium. Moreover, the first feature being “above” the second feature may mean that the first feature is directly above or obliquely above the second feature, or simply means that the first feature is higher in level than the second feature. The first feature being below the second feature may mean that the first feature is directly below or obliquely below the second feature, or simply means that the first feature is lower in level than the second feature.

### Embodiment 1

An image forming device (also called an imaging device, an electronic imaging device) of the present disclosure may be a copier, a fax machine, a printer (laser beam printer, LED printer, etc.), a multi-function printer, etc. A laser beam printer will be used as an example to illustrate the present disclosure. A processing cartridge may be disassembled from a main assembly of the image forming device. When a consumable in the processing cartridge is used up, an old consumable cartridge may need to be removed and a new consumable cartridge may need to be installed. The processing cartridge may contain developers (for example, toners), and the processing cartridge may also be called a processing box, a cartridge, a toner container, a toner cartridge, etc. In this embodiment, a drum unit 108 may also be detachable. When replacing the drum unit, the drum unit 108 on the original consumable cartridge may be removed, and then a new drum unit 108 may be installed on the processing cartridge, and then the processing cartridge may be reinstalled on the main assembly of the device. A drum drive transmission unit 203 of this embodiment may adopt a drum drive transmission unit in existing technologies.

As shown in FIG. 8, the processing cartridge may include a drum unit 108, a developing unit 109 and an end cover. The end cover may include a driving side end cover 116 and a non-driving side end cover 117. The drum unit 108 may include a photosensitive frame 115 (one of the processing cartridge housings), a photosensitive drum 104 rotatably supported on the photosensitive frame 115, a charging roller, and a coupling 14 provided at the end of the photosensitive drum 104. The coupling 14 may be engaged with the drum drive transmission unit 203 of the main assembly to receive the driving force. The developing unit 109 may include a developing frame 125 (one of the processing cartridge housings), a developing roller 106 rotatably supported on the developing frame 125, a developing driving force receiving unit 132, and a protective cover 128 fixed to an end of the developing frame 125. When the processing cartridge is mounted on the main assembly, the developing driving force receiving unit 132 may be engaged with the developing driving force transmission unit on the main assembly to receive the driving force, thereby driving the developing roller 106 to rotate.

When the image forming device is not working, the developing roller 106 and the photosensitive drum 104 may need to be separated by a certain distance to avoid the developing roller 106 and the photosensitive drum 104 from being in contact for a long time, which may cause the photosensitive drum 104 to be contaminated by the excess developer attached to the developing roller 106, the developing roller 106 to be deformed, and the photosensitive drum 104 to be worn. In this embodiment, the drum unit 108 and the developing unit 109 may be connected in a relatively rotatable manner, for example, the developing unit 109 may be able to rotate relative to the drum unit 108 around the rotation axis of the developing driving force receiving unit 132, such that the developing roller 106 and the photosensitive drum 104 are in contact with or separated from each other. The drum unit 108 and the developing unit 109 may be connected by the driving side end cover 116 and the non-driving side end cover 117 arranged at the corresponding ends in the length direction of the processing cartridge. One end of the processing cartridge provided with the coupling 14 may be defined as the driving end, and the other end opposite may be defined as the non-driving end.

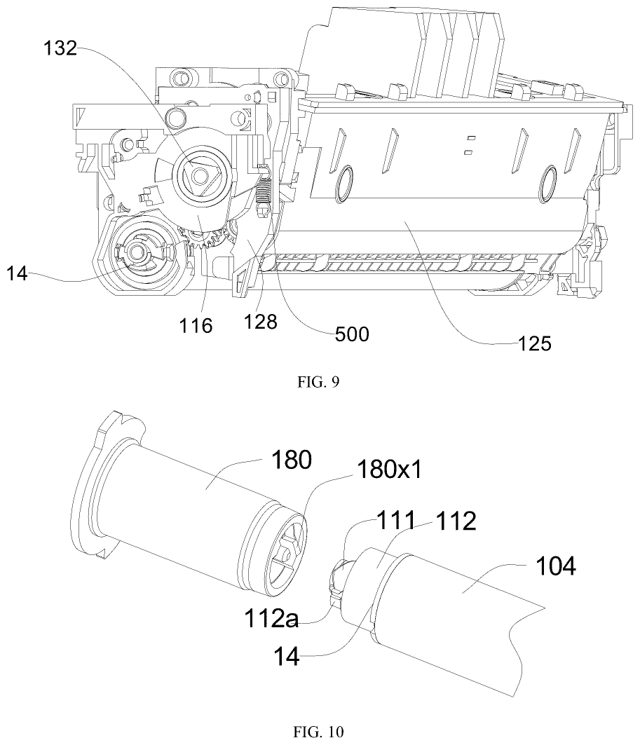

As shown in FIG. 9, in this embodiment, the processing cartridge may be provided with a tension spring 500, one end of which is arranged on the protective cover 128, and the other end is arranged on the driving side end cover 116. Because of the tension of the tension spring 500 acting on the developing frame 125, the lower end of the developing frame 125 has a tendency to rotate around the center of rotation away from the photosensitive frame 115, the photosensitive frame 115 may be away from the developing frame 125, and the photosensitive drum 104 and the developing roller may not be in contact. When the image forming device starts the developing operation, the developing driving force transmission unit on the main assembly may output the rotation driving force, and the driving force may be transmitted from the developing driving force receiving unit 132 to the developing frame 125. Since the torque of the driving force and the force of the self-weight of the developing frame 125 are much larger than the force of the tension spring 500 on the developing frame 125, the entire developing frame 125 may rotate clockwise around the rotation center, such that the photosensitive drum 104 contacts the developing roller and the developing operation is able to be performed.

FIG. 10 to FIG. 12 schematically show a drum unit according to the first embodiment of the present disclosure. The coupling 14 may include a middle accommodation member 111, a sleeve 112 and a fixing member 113.

The sleeve 112 may be rotatably sleeved outside the middle accommodation member 111, and the sleeve 112 may be fixedly connected to the photosensitive drum 104. The sleeve 112 is provided with power transmission parts 112a projecting in a circumferential direction away from the photosensitive drum 104. One or more power transmission parts 112a may be provided. The middle accommodation member 111 may be provided in a through hole 1122 of the sleeve 112, and matching steps may be provided on the outer wall of the middle accommodation member 111 and the inner wall of the through hole 1122 to limit the axial movement of the middle accommodation member 111 in the direction toward the photosensitive drum. One end of the middle accommodation member 111 may be provided with a guide portion 111a and a snap-fit groove 111b. The guide portion 111a may be an inclined guide surface. When the middle accommodation member 111 is engaged with the first braking force engaging member 204 and/or the second braking force engaging member 208 of the driving force transmission member 180, the guide portion 111a may guide the first braking force engaging member 204 and/or the second braking force engaging member 208 to enter the snap-fit groove 111b to snap-fit with the middle accommodation member 111, thereby making the first braking force engaging member 204 and/or the second braking force engaging member 208 engage and transmit.

The fixing member 113 may be fixed to the end of the middle accommodation member 111 facing the photosensitive drum 104, and abut against the end of the sleeve 112 facing the direction of the photosensitive drum, thereby limiting the axial movement of the middle accommodation member 111 in the direction away from the photosensitive drum. The fixing member 113 may be provided with a mounting hole 1131 matching the positioning hole 1111 at the end of the middle accommodation member 111, for inserting a screw to form a fixed connection with the middle accommodation member 111. The outer diameter of the fixing member 113 can be set to be larger than the inner diameter of the through hole 1122 of the sleeve 112, so that the fixing member 113 abuts against the end of the sleeve 112 so that the middle accommodation member 111 is not separated from the sleeve 112 in the direction away from the photosensitive drum.

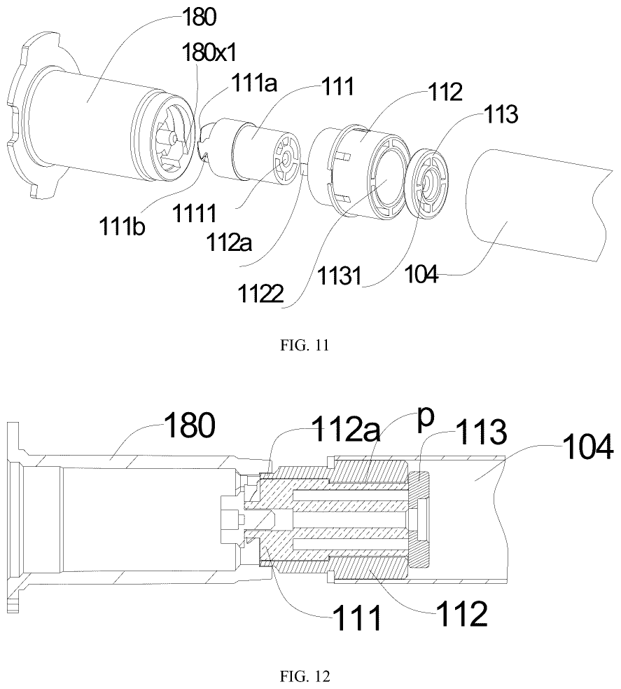

As shown in FIG. 11 and FIG. 12, at least a portion of the coupling 14 may be engaged with the driving force transmission member 180 to receive the driving force and transmit the driving force to the photosensitive drum 104.

In this embodiment, the sleeve 112 of the coupling 14 may be engaged with the driving force transmission member 180. The power transmission part 112a on the sleeve 112 can abut against the inclined surface 180x1 of the driving force transmission part 180v on the driving force transmission member 180 to receive the driving force. The sleeve 112 may be in contact with the inner wall of the photosensitive drum 104, and transmit the driving force received from the driving force transmission member 180 to the photosensitive drum 104. Although the middle accommodation member 111 is engaged with the driving force transmission member 180, there may be a gap P between the middle accommodation member 111 and the sleeve 112 in the circumferential direction, and the middle accommodation member 111 and the sleeve 112 may be able to rotate relative to each other. The driving force received by the sleeve 112 from the driving force transmission member 180 may not be transmitted to the middle accommodation member 111, and the driving force received by the middle accommodation member 111 from the driving force transmission member 180 may not be transmitted to the sleeve 112 and the photosensitive drum 104. That is, the power of the photosensitive drum 104 may only come from the sleeve 112.

This embodiment provides a new driving force transmission method, and the power transmission of this method may be stable.

### Embodiment 2

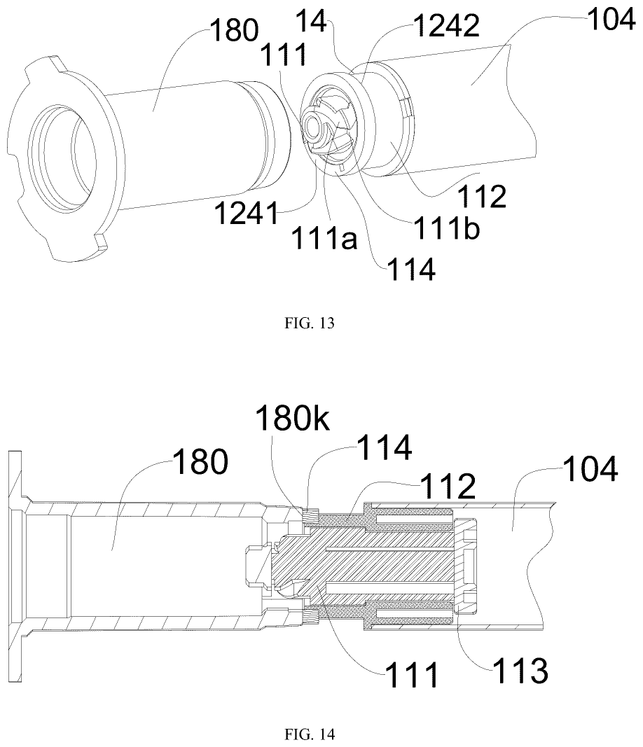

In another embodiment shown in FIG. 13 and FIG. 14 which show a drum unit, this embodiment is substantially the same as Embodiment 1, and the main difference is that: the sleeve 112 may not be provided with a power transmission part 112a, and the driving force may be transmitted by generating friction between an annular transmission part 114 provided on the sleeve 112 and the driving force transmission member 180.

The coupling 14 may also include an annular transmission part 114. A first end 1241 of the annular transmission part 114 may be used to form friction with the end face 180k of the cylindrical part 180c of the driving force transmission member 180, and the second end 1242 thereof may be fixedly sleeved on the sleeve 112. The sleeve 112 may be in contact with the inner wall of the photosensitive drum 104, and the driving force may be transmitted to the photosensitive drum 104 through the annular transmission part 114. Similar to Embodiment 1, although the middle accommodation member 111 is engaged with the driving force transmission member 180, there may be a gap P between the driving force transmission member 180 and the sleeve 112 in the circumferential direction, and the driving force transmission member 180 and the sleeve 112 may be able to rotate relatively, and the driving force received by the sleeve 112 from the driving force transmission member 180 may not be transmitted to the middle accommodation member 111, and the driving force received by the middle accommodation member 111 from the driving force transmission member 180 may not be transmitted to the sleeve 112 and the photosensitive drum 104. That is, the power of the photosensitive drum 104 may only come from the sleeve 112.

Optionally, the annular transmission part 114 may be made of a material with a large friction coefficient such as rubber, silicone, etc., as long as it can generate friction between the end surface 180k.

### Embodiment 3

Another embodiment is substantially the same as Embodiment 2, and the main difference is that the annular transmission part 114 is set differently.

As shown in FIG. 19 to FIG. 21 which illustrate the photosensitive drum 104 and the coupling 14, in another embodiment, the coupling 14 may include an annular transmission part 114, a sleeve 112, a middle accommodation member 111, and a fixing member 113 for fixing the middle accommodation member 111. The annular transmission part 114 may be configured as a friction member having a friction surface. The annular transmission part 114 may have a first friction surface 114a and a second friction surface 114b to transmit the driving force when abutting against the end of the cylindrical part 180c of the driving force transmission member 180 of the image forming device M. The first friction surface 114a may contact the outer circumferential surface of the cylindrical part 180c, and the second friction surface 114b may contact the end surface 180k of the cylindrical part 180c. In some other embodiments, only the second friction surface 114b may be provided. The annular transmission part 114 may also be set as an annular member with only one friction surface and made of elastic material (such as rubber) with large friction force. When the annular transmission part 114 abuts against the driving force transmission member 180, the annular transmission part 114 may be pressed by the end of the cylindrical part 180c of the driving force transmission member 180 and may be recessed, forming a first friction surface 114a and a second friction surface 114b by itself, generating a large friction force to transmit the driving force.

The sleeve 112 may be installed on the photosensitive drum 104 and may be provided with one or more contact surfaces 112b at one end away from the photosensitive drum 104 in the axial direction. The annular transmission part 114 may be arranged on the one or more contact surfaces 112b of the sleeve 112. The sleeve 112 may be fixedly connected to the photosensitive drum 104, and the sleeve 112 and the photosensitive drum 104 may be integrally formed or split structures.

The middle accommodation member 111 may be rotatably arranged in the sleeve 112, that is, the middle accommodation member 111 and the sleeve 112 may not form a transmission. The middle accommodation member 111 may be provided with a receiving portion 111c of a hollow cylindrical structure for receiving a positioning boss 180i of the driving force transmission member 180, and may be used to receive the snap-fitting groove 111b of the second braking force engagement member 208.

The coupling 14 may also include a fixing member 113 disposed at one end close to the photosensitive drum 104, and the fixing member 113 and the middle accommodation member 111 may be fixedly connected by pins or screws.

As shown in FIG. 20, when installing the drum unit 30, the annular transmission part 114 may be first fixed to the sleeve 112, the middle accommodation member 111 may be disposed in the sleeve 112, and then the fixing member 113 may be fixedly connected to the middle accommodation member 111. The sleeve 112 then may be fixedly disposed on the photosensitive drum 104.

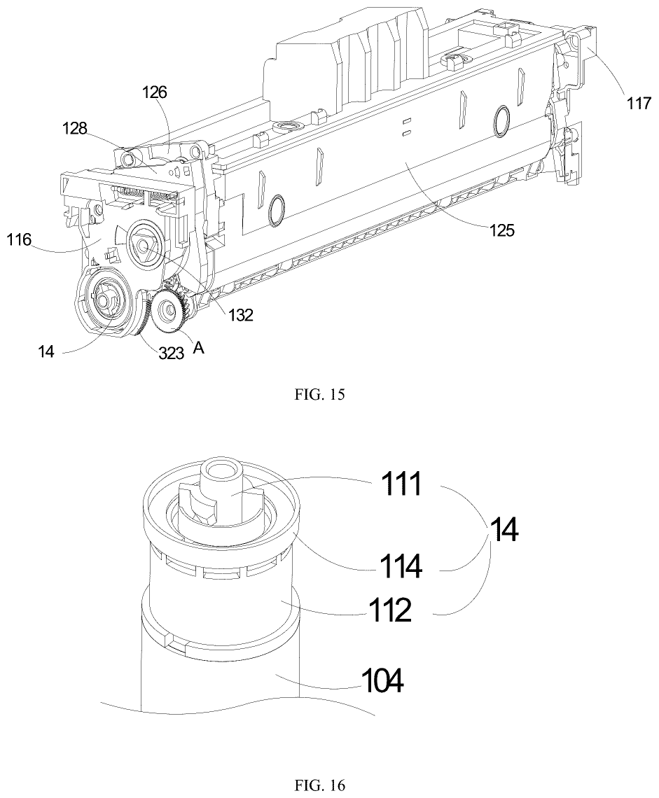

As shown in FIG. 15, in some embodiments, the structures of the drum unit and the processing cartridge provided by the present embodiment may also be applicable to the drum roller contacting or separated from the processing cartridge. Therefore, the sleeve 112 may also be provided with a structure corresponding to the contact and separation of the drum roller and the processing cartridge. In one embodiment, the rotating member 323 sleeved on the sleeve 112 may be a partial structure that cooperates with the gear A on the developing frame to realize the contact and separation of the drum roller and the processing cartridge.

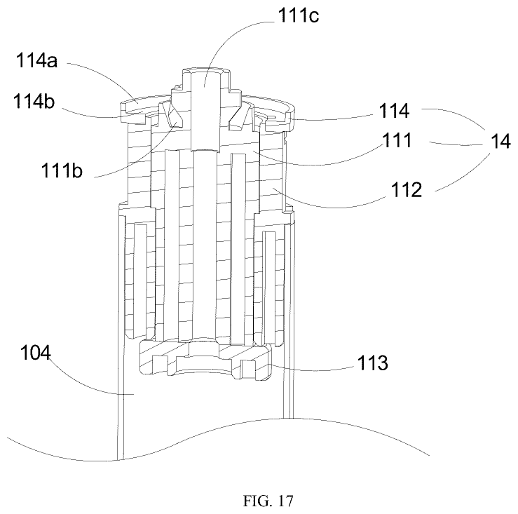

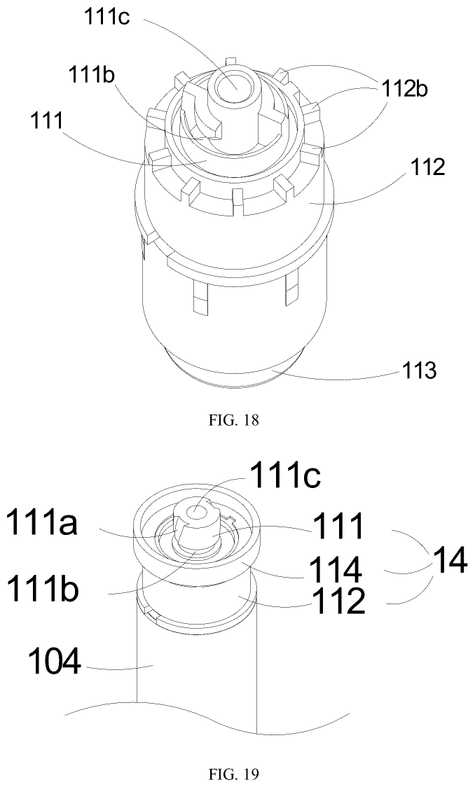

As shown in FIG. 16 to FIG. 18, when the processing cartridge is installed in place in the image forming device and the door cover 11 of the image forming device is closed, the driving force transmission member 180 may protrude in a direction close to the processing cartridge (along the M1B direction), the receiving portion 111c of the middle accommodation member 111 may receive the positioning boss 180i of the driving force transmission member 180, and the second braking force engaging member 208 of the driving force transmission member 180 may be engaged along the snap-fitting groove 111b of the middle accommodation member 111 to ensure the stable connection between the driving force transmission member 180 and the coupling 14. At this time, the first friction surface 114a and the second friction surface 114b of the annular transmission part 114 may abut against the cylindrical part 180c of the driving force transmission member 180. When the cylindrical part 180c starts to rotate, a large friction force may be generated between the first friction surface 114a and the second friction surface 114b and the cylindrical part 180c. Therefore, the annular transmission part 114 may be driven to rotate by the cylindrical part 180c of the driving force transmission member under the action of the friction force, and then the driving force may be transmitted to the photosensitive drum 104 through the sleeve 112, such that the photosensitive drum 104 obtains a stable driving force.

In this embodiment, because of the connection relationship between the above-mentioned components, the middle accommodation member 111 may not transmit the force received from the second braking force engaging member 208 of the driving force transmission member 180 to the photosensitive drum 104, and the middle accommodation member 111 may be only used to engage the second braking force engaging member 208 to ensure the stable connection between the driving force transmission member 180 and the coupling 14. The coupling driving mode of the processing cartridge of this embodiment may be simple, easy to install, and have a stable connection, which may solve the problems of unstable connection between the photosensitive drum and the main assembly of the image forming device and unsmooth drive transmission in the existing processing box to achieve the effect of stable drive connection and smooth drive force transmission, thereby improving the quality of the processing cartridge.

### Embodiment 4

Another embodiment of the present disclosure provides another drum unit and another processing cartridge. Compared with Embodiment 3, the middle accommodation member 111 may have a different structure.

As shown in FIG. 19 which illustrates a coupling 14, the middle accommodation member 111 may be provided with a receiving portion 111c of a hollow cylindrical structure for receiving the positioning boss 180i of the driving force transmission member 180, a snap-fitting groove 111b for receiving the second braking force engagement member 208, and a guiding portion 111a for guiding the second braking force engagement member 208 to the snap-fitting groove 111b. The snap-fitting groove 111b may be an annular groove recessed radially at the outer circumferential surface of the receiving portion 111c, and the guiding portion 111a may be a guiding groove extending and formed on the outer circumferential surface of the receiving portion 111c in a direction inclined to the axial direction.

When the processing cartridge is installed in place in the image forming device and the door cover 11 of the image forming device is closed, the driving force transmission member 180 may protrude in the direction close to the processing cartridge 300 (along the M1B direction), the receiving portion 111c of the middle accommodation member 111 may receive the positioning boss 180i of the driving force transmission member 180, and the second braking force engagement member 208 of the driving force transmission member 180 may move along the guide portion 111a of the middle accommodation member 111 to the snap-fitting groove 111b. At this time, the second braking force engagement member 208 may be axially engaged with the snap-fitting groove 111b (i.e., fixed in the axial direction) to ensure that the driving force transmission member 180 is firmly connected to the coupling shaft. The first friction surface 114a and the second friction surface 114b of the annular transmission part 114 may abut against the cylindrical part 180c of the driving force transmission member 180. When the cylindrical part 180c of the driving force transmission member starts to rotate, a large friction force may be generated between the first friction surface 114a and the second friction surface 114b and the cylindrical part 180c. Therefore, the annular transmission part 114 may be driven to rotate by the cylindrical part 180c of the driving force transmission member under the action of the friction force, and then the driving force may be transmitted to the photosensitive drum 104 through the sleeve 112, such that the photosensitive drum 104 obtains a stable driving force.

It should be noted that in this embodiment, when the second braking force engaging member 208 of the driving force transmission member 180 is axially engaged with the snap-fitting groove 111b of the middle accommodation member 111, the second braking force engaging member 208 may move along the circumferential direction of the snap-fitting groove 111b, and the driving force of the second braking force engaging member 208 may not be transmitted to the middle accommodation member 111 through the snap-fitting groove 111b. When the friction between the second braking force engaging member 208 and the snap-fitting groove 111b is large such that the middle accommodation member 111 is driven to rotate (that is, the second braking force engaging member 208 and the snap-fitting groove 111b form a transmission), because of the connection relationship between the components, the middle accommodation member 111 may not form a transmission with the sleeve 112, and may not transmit the received driving force to the photosensitive drum 104. The middle accommodation member 111 may only be used to axially engage the second braking force engaging member 208 to ensure the stability of the engagement of the driving structure. This driving method may have a simple structure, may be easy to install, may have a stable connection, and may transmit the driving force smoothly, which is conducive to the efficient operation of the image forming device.

### Embodiment 5

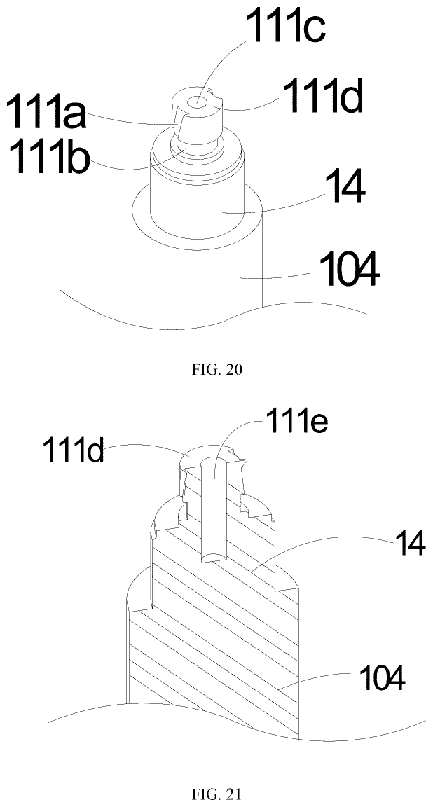

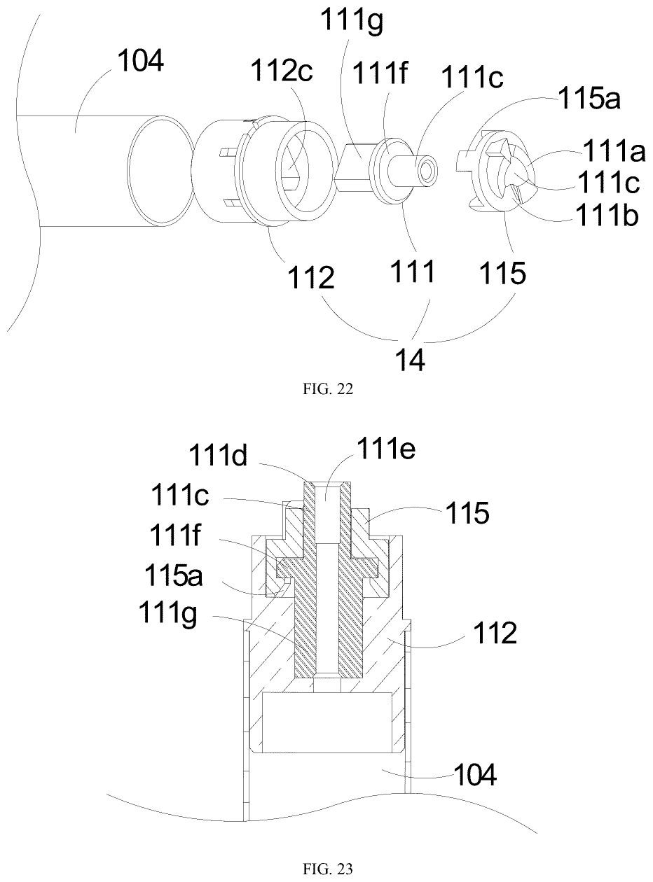

Another embodiment provides another coupling. As shown in FIG. 20 and FIG. 21 which illustrate the photosensitive drum 104 and the coupling 14 provided by the present embodiment, the coupling 14 may only be provided with a middle accommodation member 111, and no sleeve 112 and fixing member 113 are provided.

The middle accommodation member 111 may include a receiving portion 111c, and a guide portion 111a and a snap-fit groove 111b may be provided on the outer circumferential surface of the receiving portion 111c. The snap-fit groove 111b may be an annular groove that is concave in the radial direction at the outer circumferential surface of the receiving portion 111c, and the guide portion 111a may be a guide groove formed on the outer circumferential surface of the receiving portion 111c and extending in a direction inclined to the axial direction. The receiving portion 111c may be also provided with a friction end face 111d and a middle through hole, and the middle through hole may be used to receive the positioning boss 180i of the driving force transmission member 180. A friction side wall 111e may be provided on the inner side wall of the middle through hole.

The friction end surface 111d may abut against the inner abutting surface 180cl of the driving force transmission member 180 to transmit the driving force. The friction side wall 111e may generate a large friction with the outer circumferential surface of the positioning boss 180i to transmit the driving force together with the friction end surface 111d. The guide portion 111a may be used to guide the second braking force engagement member 208 of the driving force transmission member 180 to move into the snap-fitting groove 111b. The coupling 14 may be fixedly connected to one end of the photosensitive drum 104, and the coupling 14 and the photosensitive drum 104 may be integrally formed or may be separated structures. To increase the friction coefficient of the friction end surface 111d and the friction side wall 111e and ensure the stable transmission of the driving force, surface treatment may be performed on the friction end surface 111d and the friction side wall 111e. In the present embodiment, preferably, the friction end surface 111d and the friction side wall 111e may set as rubber surfaces to increase the friction force when combined with the driving force transmission component 180. In some other embodiments, any surface treatment method that may achieve the same driving force transmission stability effect is acceptable.

When the processing cartridge is installed in place in the image forming device and the door cover 11 of the image forming device is closed, the driving force transmission member 180 may protrude in the direction close to the processing cartridge 300 (along the M1B direction), the receiving portion 111c of the coupling 14 may receive the positioning boss 180i of the driving force transmission member 180 and the friction side wall 111e may contact the inner abutment surface 180c1 of the driving force transmission member 180. The second braking force engaging member 208 of the driving force transmission member 180 may move along the guiding portion 111a of the coupling 14 to the snap-fitting groove 111b. The second braking force engaging member 208 may be axially engaged with the snap-fitting groove 111b to ensure the stable connection between the driving force transmission member 180 and the coupling 14. At this time, the friction end surface 111d may be in contact with the inner abutting surface 180c1 of the driving force transmission member 180. When the driving force transmission member 180 starts to rotate, because of the large friction force generated between the inner abutting surface 180cl and the friction end surface 111d, the friction end surface 111d may be driven to rotate by the driving force transmission member 180 under the action of the friction force, and then the driving force may be transmitted to the photosensitive drum 104, such that the photosensitive drum 104 obtains a stable driving force. This driving method may have a simple structure, may be easy to install, may achieve a stable connection, and may transmit the driving force smoothly, which is conducive to the efficient operation of the imaging device.

### Embodiment 6

In another embodiment, the structure may be substantially the same as Embodiment 5, the main difference being that the coupling 14 may further include a sleeve 112 and an end accommodation member 115.

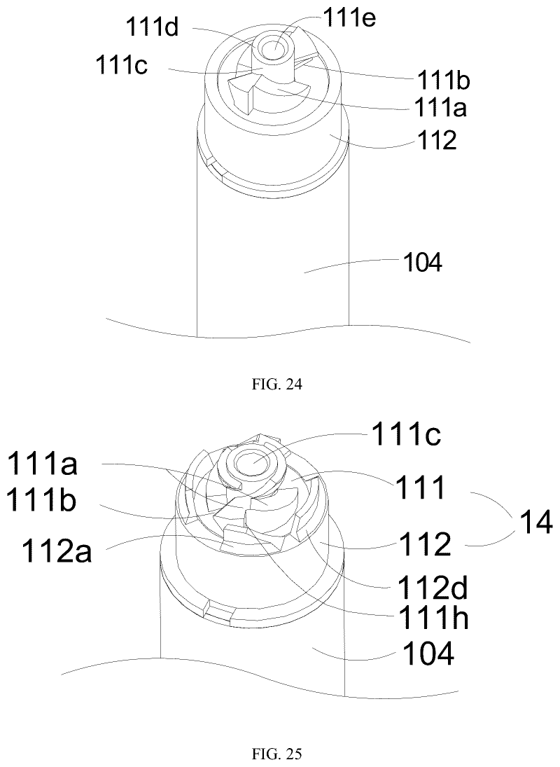

As shown in FIG. 22 to FIG. 24, which illustrates the photosensitive drum 104 and the coupling 14, the coupling 14 may include a middle accommodation member 111, a sleeve 112, and an end accommodation member 115.

The middle accommodation member 111 may be configured as a component that is able to transmit driving force and has a hollow cylindrical portion. The middle accommodation member 111 may include a receiving portion 111c, a frustum 111f and an engaging head 111g. The receiving portion 111c may include a friction end face 111d and a friction side wall 111e. When the middle accommodation member 111 is engaged with the driving force transmission member 180, the receiving portion 111c of the middle accommodation member 111 may receive the positioning boss 180i of the driving force transmission member 180, the positioning boss 180i may abut against the friction side wall 111e, and the friction end face 111d may abut against the inner abutment surface 180cl of the driving force transmission member 180, thereby generating a larger friction force that is able to drive the middle accommodation member 111 to rotate. Therefore, the driving force may be transmitted to the middle accommodation member 111.

The middle accommodation member 111 and the sleeve 112 may be fixedly connected, and the engaging head 111g may be set as a triangular column structure to engage with the engaging portion 112c on the sleeve 112 to transmit the driving force. The middle accommodation member 111 may also be provided with a frustum 111f that abuts the end accommodation member 115.

The sleeve 112 may be fixedly mounted on the photosensitive drum 104 and may be provided with an engaging portion 112c for engaging with the engaging head 111g of the middle accommodation member 111 to receive the driving force. The sleeve 112 and the photosensitive drum 104 may be integrally formed or may be separated structures.

The coupling 14 may also include an end accommodation member 115 arranged at the end of the sleeve 112. The end accommodation member 115 may be fixedly arranged with the middle accommodation member 111 and the sleeve 112 in the axial direction (i.e., it may not be relatively displaced in the axial direction), and may be rotatably arranged in the axial direction. That is, the end accommodation member 115 may not form a transmission relationship with the middle accommodation member 111 and the sleeve 112. The end accommodation member 115 may include a snap-fit groove 111b for engaging the driving force transmission member 180, and the receiving portion 111c of the middle accommodation member 111 may penetrate a penetration portion provided therein, such that the end accommodation member 115 is installed on a mounting portion 115a of the middle accommodation member 111, and a guide portion 111a for guiding the second braking force engagement member 208 of the driving force transmission member 180. The guide portion 111a may be an inclined surface inclined relative to the axial direction. In this embodiment, the mounting portion 115a may be connected to the middle accommodation member 111 in the form of a buckle, such that the end accommodation member 115 is fixed to the middle accommodation member 111 in the axial direction while being able to rotate circumferentially relative to the middle accommodation member 111.

As shown in FIG. 23, in this embodiment, during installation, the end accommodation member 115 may be first connected to the middle accommodation member 111 in a snap-fit manner, such that a portion of the receiving portion 111c of the middle accommodation member 111 is exposed to the outside of the end accommodation member 115 in the axial direction to receive the driving force. Then, the engaging head 111g of the middle accommodation member 111 may be fixedly connected to the engaging portion 112c on the sleeve 112 by a pin or a screw, and the sleeve 112 may be fixedly set on the photosensitive drum 104.

In some embodiments, the structures of the drum unit and the processing cartridge provided by the present embodiment are applicable to the drum roller in contact with or being separated from the processing cartridge. Therefore, the sleeve 112 may also be provided with a structure corresponding to the drum roller in contact with or being separated from the processing cartridge. In one embodiment, the rotating member 323 sleeved on the sleeve 112 may be a partial structure that cooperates with the gear A on the developing frame to realize the drum roller in contact with or being separated from the processing cartridge.

As shown in FIG. 22 to FIG. 24, when the processing cartridge is installed in place in the image forming device and the door cover 11 of the image forming device is closed, the driving force transmission member 180 may protrude in the direction close to the processing cartridge 300 (along the M1B direction), and the guide portion 111a of the end accommodation member 115 may guide the second braking force engaging member 208 of the driving force transmission member 180 to the engaging groove 111b of the end accommodation member 115, such that the two are axially engaged to ensure the stable connection between the driving force transmission member 180 and the coupling 14. At this time, the positioning boss 180i of the driving force transmission member 180 may be received by the receiving part 111c of the middle accommodation member 111, the positioning boss 180i may abut against the friction side wall 111e, and the friction end face 111d may abut against the inner abutting face 180c1 of the driving force transmission member 180. When the driving force transmission member 180 starts to rotate, because of the large friction force generated between the friction end face 111d and the friction side wall 111e and the inner abutting face 180cl and the positioning boss 180i respectively, the middle accommodation member 111 may be driven to rotate by the driving force transmission member 180 under the action of the friction force, and then the driving force may be transmitted to the photosensitive drum 104 through the sleeve 112, so that the photosensitive drum 104 obtains a stable driving force.

It should be noted that, in this embodiment, because of the connection relationship between the above-mentioned components, no transmission relationship may be formed between the end accommodation member 115 and the sleeve 112 and the middle accommodation member 111. Therefore, the end accommodation member 115 may not transmit the force received from the second braking force engaging member 208 of the driving force transmission member 180 to other components, and the end accommodation member 115 may be only used to engage the second braking force engaging member 208 to ensure the stable connection between the driving force transmission member 180 and the coupling 14.

The coupling driving method of the processing cartridge of this embodiment may be simple, easy to install, and have a stable connection. The problems of unstable connection between the photosensitive drum and the main assembly of the image forming device and unsmooth drive transmission in the existing processing cartridges may be resolved, and the effect of stable drive connection and smooth drive force transmission may be achieved, thereby improving the quality of the processing cartridge.

### Embodiment 7

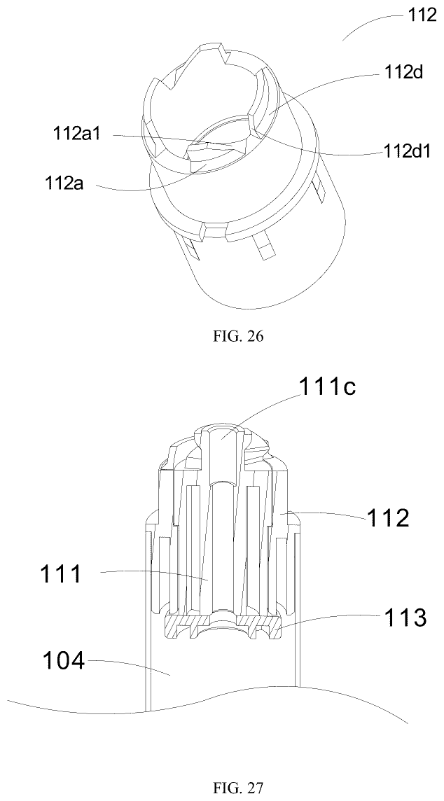

In another embodiment, the structure may be similar to Embodiment 1. As shown in FIG. 25 to FIG. 27 which illustrate another photosensitive drum 104 and another coupling 14. The coupling 14 may include a sleeve 112, a middle accommodation member 111, and a fixing member 113 for fixing the middle accommodation member 111.

The sleeve 112 may be provided with power transmission parts 112a and abutment parts 112d protruding in the direction away from the photosensitive drum along the circumferential direction. In one embodiment, there may be two power transmission parts 112a and two abutment parts 112d, which are arranged at intervals in the circumferential direction. The sleeve 112 may be fixedly mounted on the photosensitive drum 104, and the middle accommodation member 111 may be rotatably arranged in the sleeve 112. One power transmission part 112a may be provided with a driving force receiving surface 112a1 to receive the driving force transmitted by the inclined surface 180x1 of the driving force transmission member 180, and one abutment part 112d may be provided with an abutment surface 112d1 abutting against the vertical surface 180x3 of the driving force transmission member 180 to ensure that the driving force transmission part 180v of the driving force transmission member 180 is in the correct working position during the engagement process and the driving force transmission process, thereby realizing stable transmission of the driving force.

The middle accommodation member 111 may be provided with a receiving portion 111c of a hollow cylindrical structure for receiving the positioning boss 180i of the driving force transmission member 180, a guiding portion 111a for guiding the second braking force engagement member 208 and the first braking force engagement member 204, a snap-fitting groove 111b for engaging the second braking force engagement member 208 and the first braking force engagement member 204, and a limiting surface 111h for abutting against the vertical surface 180x2 of the driving force transmission member 180 to limit and ensure that the inclined surface 180x1 and the driving force receiving surface 112al are stably abutted. The guiding portion 111a may be set as an inclined surface inclined in the axial direction of the coupling 14. In this embodiment, the setting method of the guiding portion 111a may be conducive to the guiding portion 111a being able to guide the second braking force engagement member 208 and the first braking force engagement member 204 to the snap-fitting groove 111b regardless of the engagement of the coupling 14 and the driving force transmission member 180 from any position.

The coupling 14 may also include a fixing member 113 disposed at one end near the photosensitive drum 104. The fixing member 113 and the middle accommodation member 111 may be fixedly connected by pins or screws. The middle accommodation member 111 may be rotatably disposed in the sleeve 112, and the two may be non-transmission connected. The fixing member 113 may only ensure that the middle accommodation member 111 does not come out in the axial direction in the sleeve 112. Therefore, when the middle accommodation member 111 receives the force from the driving force transmission member 180, the middle accommodation member 111 may not transmit the force to the sleeve 112, that is, may not drive the photosensitive drum 104 to rotate.

As shown in FIG. 27, during installation, the middle accommodation member 111 may be first disposed in the sleeve 112, and then the fixing member 113 may be fixedly connected to the middle accommodation member 111. The sleeve 112 then may be installed on the photosensitive drum 104.

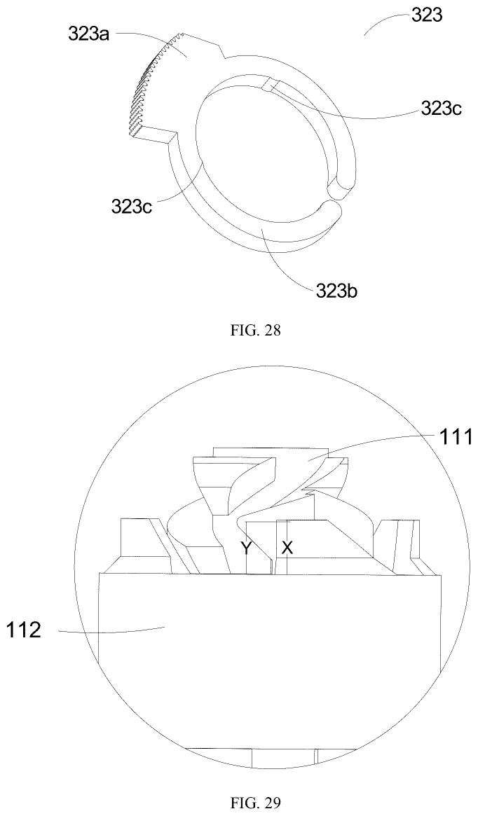

As shown in FIG. 28, the structures of the drum unit and the processing cartridge provided by the present embodiment are applicable to the drum roller in contact with or being separated from the processing cartridge. Therefore, the sleeve 112 may also be provided with a structure corresponding to the drum roller in contact with or being separated from the processing cartridge. In one embodiment, the rotating member 323 sleeved on the sleeve 112 may be a partial structure that cooperates with the gear A on the developing frame to realize the drum roller in contact with or being separated from the processing cartridge. As shown in FIG. 28, the rotating member 323 may be a roughly annular member, and the rotating member 323 may be provided with a gear portion 323a and an annular mounting portion 323b. The gear portion 323a may be used to cooperate with the gear A on the developing frame, and the annular mounting portion 323b may include an opening and one or more friction protrusions 323c may be provided on the annular mounting portion 323b to increase the friction between the rotating member 323 and the sleeve 112.

As shown in FIG. 25 to FIG. 27, when the processing cartridge is installed in place in the image forming device and the door cover 11 of the image forming device is closed, the driving force transmission member 180 may protrude in the direction close to the processing cartridge 300 (along the M1B direction). The receiving portion 111c of the middle accommodation member 111 may receive the positioning boss 180i of the driving force transmission member 180, and the second braking force engagement member 208 and the first braking force engagement member 204 of the driving force transmission member 180 may move along the guiding portion 111a of the middle accommodation member 111 to the engaging groove 111b of the middle accommodation member 111, such that the second braking force engagement member 208 and the first braking force engagement member 204 engage with the engaging groove 111b to ensure the stable connection between the driving force transmission member 180 and the coupling 14. At this time, the middle accommodation member 111 may receive the force from the driving force transmission member 180 such that the middle accommodation member 111 idles in the sleeve 112. Also, the power transmission part 112a and the abutment part 112d on the sleeve 112 may abut against the driving force transmission member 180. The driving force receiving surface 112a1 of the power transmission part 112a may abut against the inclined surface 180x1, the abutment surface 112d1 of the abutment part 112d may abut against the vertical surface 180x3, and the limiting surface 111h of the middle receiving piece 111 may abut against the vertical surface 180x2 of the driving force transmission member 180. Therefore, the driving force may be transmitted from the inclined surface 180x1 of the driving force transmission member 180 to the photosensitive drum 104 through the driving force receiving surface 112al of the power transmission part 112a of the sleeve 112, such that the photosensitive drum 104 obtains a stable driving force.

It should be noted that, in this embodiment, because of the connection relationship between the above-mentioned components, the middle accommodation member 111 may not transmit the force received from the braking force engaging members of the driving force transmission member 180 to the photosensitive drum 104, and the middle accommodation member 111 may be only used to engage the second braking force engaging member 208 and the first barking force engaging member 204 and to limit the driving force transmission member 180, to ensure the stable connection between the driving structure.

As shown in FIG. 29, in some embodiments, the blade height X of the sleeve 112 may be related to the distance Y between the guide portion 111a and the surface plane of the sleeve 112 (i.e., the end surface of the sleeve 112). The blade height X and the distance Y between the guide portion 111a and the surface plane of the sleeve 112 may be set correspondingly according to the size and position of the relevant structure of the driving force transmission member 180. In some embodiments, the height X may be set to be substantially the same as the distance Y. When the blade height X is higher than the distance Y between the guide portion 111a and the surface plane of the sleeve 112, the second braking force engagement member 208 and the first braking force engagement member 204 of the driving force transmission member 180 may fail to engage with the engagement groove 111b of the middle accommodation member 111. When the blade height X is lower than the distance Y between the guide portion 111a and the surface plane of the sleeve 112, the driving force receiving surface 112al may be reduced, resulting in unstable driving force reception.

In the present embodiment, the driving method of the coupling in the processing cartridge may be simple, easy to install, and have a stable connection. The problems of unstable connection between the photosensitive drum and the main assembly of the image forming device and unsmooth drive transmission on the existing processing cartridge may be alleviated, achieving the effect of stable drive connection and smooth drive force transmission, thereby improving the quality of the processing cartridge.

### Embodiment 8

In another embodiment, the photosensitive drum 104 may not obtain the driving force through the coupling 14, and may obtain the driving force through the developing driving force receiving unit 132 of the developing unit 109.

The developing unit 109 of the present disclosure further includes, at the driving end, a transmission gear 31, a developing gear 32, and a bearing 126. The bearing 126 may be arranged between the end of the developing frame 125 and the protective cover 128.

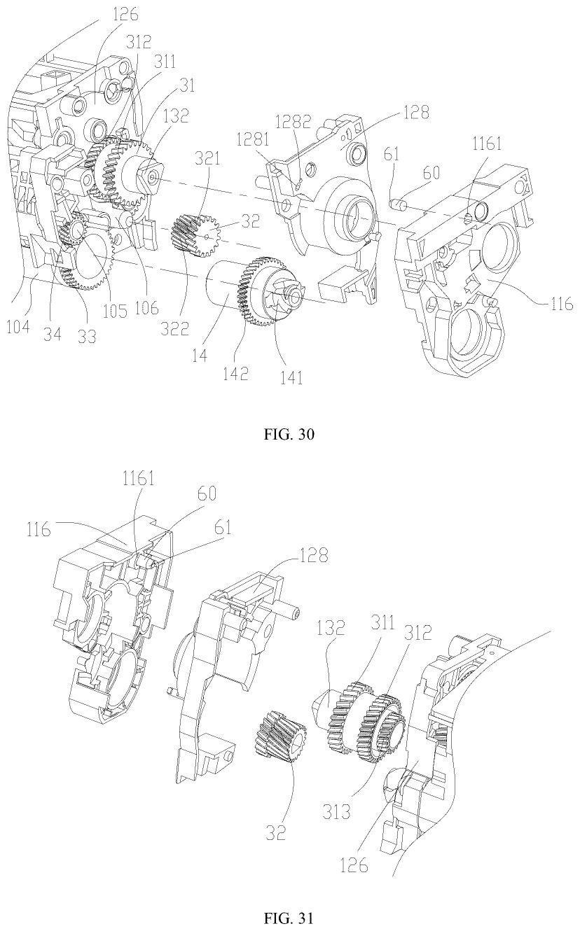

As shown in FIG. 30 and FIG. 31, the protective cover 128 may be provided with a first positioning hole 1281 and a second positioning hole 1282. The diameter of the first positioning hole 1281 may be larger than the diameter of the second positioning hole 1282, and there may be a gap between the first positioning hole 1281 and the second positioning hole 1282. The driving side end cover 116 may be provided with a positioning protrusion at a position corresponding to the first positioning hole 1281, which is used to keep the photosensitive drum and the developing roller in a separated position or a contact position. In this embodiment, the positioning protrusion may be a ball screw 60. A fixing hole 1161 may be provided on the drive side end cover 116. The ball screw 60 may be installed in the fixing hole 1161 to be fixed to the drive side end cover 116, and one end of the ball screw 60 may be installed in the first positioning hole 1281.

The developing unit 109 may also include a developing driving force receiving unit 132. The transmission gear 31 may be coaxially fixed with the developing driving force receiving unit 132, and include a first transmission gear 311, a second transmission gear 312 and a third transmission gear 313. The developing gear 32 may be coaxially fixed with the developing roller 106. The developing gear 32 may be a double-layer gear, including a primary gear 321 and a secondary gear 322. The developing gear 32 may be meshed with the transmission gear 31 to receive the driving force from the transmission gear 31 and drive the developing roller 106 to rotate.

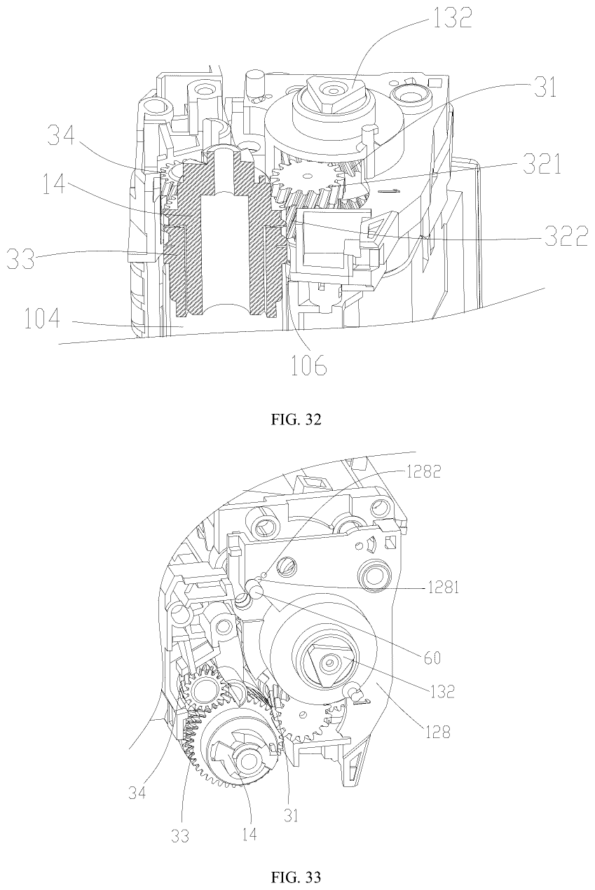

The drum unit 108 may further include a driving gear 33, a charging roller gear 34 and an intermediate gear 142 at the driving end. The charging roller gear 34 may be coaxially fixed with the charging roller 105. The coupling 14 may be provided with a driving force receiving portion 141 connected to the driving force transmission member 180, and the intermediate gear 142 may be coaxially fixed with the coupling 14 (they may be manufactured in one piece or manufactured in parts and then fixedly connected). The intermediate gear 142 may mesh with the developing gear 32 and the charging roller gear 34 at the same time, and the teeth of the intermediate gear 142 may be helical teeth or straight teeth. The photosensitive drum 104 may also be coaxially fixed with a driving gear 33 for meshing with the developing gear 32 to receive the driving force from the developing gear 32 and drive the photosensitive drum 104 to rotate. Further, as shown in FIG. 32, the coupling 14 may be rotatably arranged at one end of the photosensitive drum 104, and there may be no transmission between the coupling 14 and the photosensitive drum 104. Therefore, the coupling 14 may not transmit the driving force received from the drum drive transmission unit 203 to the photosensitive drum 104. That is, after receiving the power, the coupling 14 may be in an idling state relative to the photosensitive drum 104.

As shown in FIG. 33, when the processing cartridge is installed in the electronic imaging device, the drum drive transmission unit 203 may approach the coupling 14, and the coupling 14 may be connected with the drum drive transmission unit 203 and receive the power from the drum drive transmission unit 203, such that the intermediate gear 142 also rotates together. Since the intermediate gear 142 is meshed with the charging roller gear 34, the coupling 14 may directly transmit the power to the charging roller 105 through the intermediate gear 142 to drive the charging roller 105 to rotate. At this time, the developing driving force receiving unit 132 on the developing unit 109 may also receive the driving force from the developing driving force transmission unit in the electronic imaging device, and transmit the force to the developing gear 32 meshing therewith through the transmission gear 31. Since the driving gear 33 meshes with the developing gear 32, the driving force may be transmitted from the developing driving force receiving unit 132 to the photosensitive drum 104 through the transmission gear 31, the developing gear 32 and the driving gear 33 in sequence, thereby driving the photosensitive drum 104 to rotate. In other words, the power of the photosensitive drum 104 may come from the driving force received by the developing driving force receiving unit 132, and the power of the charging roller 105 may come from the driving force received by the coupling 14. The above technical solution provides a new driving force transmission method, and the power transmission of this method is stable.

As shown in FIG. 33, when the processing cartridge performs a developing operation, the developing driving force receiving unit 132 may rotate clockwise after receiving the driving force, thereby generating a force that causes the developing roller 106 to approach the photosensitive drum 104. Therefore, the photosensitive drum 104 and the developing drum 106 may be in a state of contact with each other (i.e., a drum-roller contact state), and the processing cartridge may perform a normal printing operation. To allow the photosensitive drum 104 and the developing roller 106 to be in closer contact with each other, the ball screw 60 provided on the driving side end cover 116 may be located in the first positioning hole 1281 of the protective cover 128, thereby preventing the developing unit 109 from moving relative to the drum unit 108.

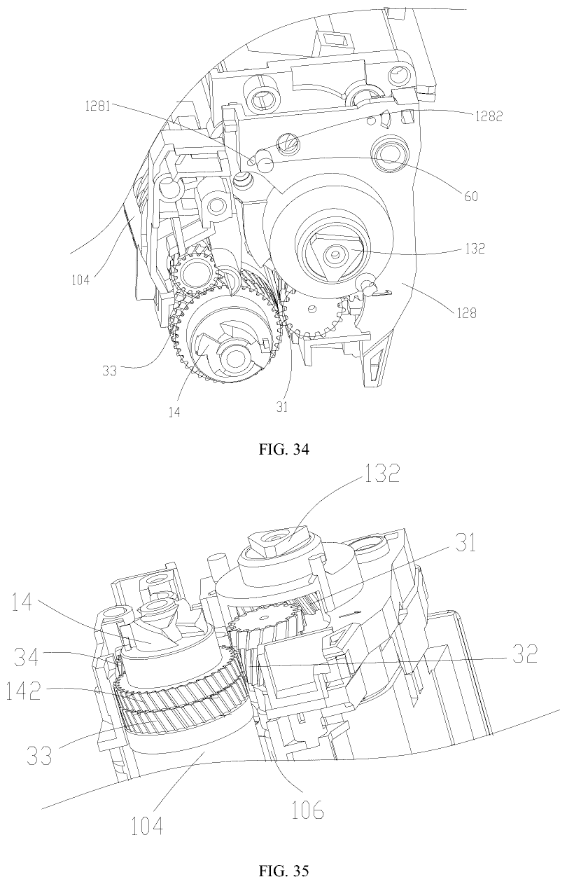

As shown in FIG. 34 and FIG. 35, when the developing operation is completed, the developing driving force transmission unit may stop outputting the driving force, the driving force transmitted to the developing driving force receiving unit 132 may disappear, and the developing driving force receiving unit 132 may stop rotating. Therefore, the developing gear 32 connected to the transmission gear 31 may also stop rotating, and may no longer transmit power to the driving gear 33. The photosensitive drum 104 may stop rotating after losing power. At this time, the drum drive transmission unit 203 may maintain the output driving force, and the coupling 14 may still receive the driving force of the drum drive transmission unit 203, such that the intermediate gear 142 and the charging roller gear 34 are still in a rotating state, and the charging roller 105 also rotates. Since the charging roller 105 is constantly rotating, the friction force generated between the charging roller 105 and the photosensitive drum 104 may be large enough, and the photosensitive drum 104 may also be driven to rotate together through the friction force between the two, thereby avoiding the situation where the photosensitive drum 104 loses the power of the developing driving force receiving unit 132 after the development operation is completed and stops rotating, and friction occurs between the transfer belt, causing the photosensitive drum 104 to be worn.

Further, since the developing gear 32 no longer rotates while the intermediate gear 142 is still rotating along with the coupling 14, there may be interference between the intermediate gear 142 and the developing gear 32. That is, the teeth of the intermediate gear 142 may apply a push force to the developing gear 32, such that the developing gear 32 drives the developing roller 106 to move in a direction away from the photosensitive drum 104. Therefore, the developing unit 109 connected to the developing roller 106 may also be forced to rotate counterclockwise, such that the steel ball screw 60 located in the first positioning hole 1281 moves to the second positioning hole 1282, thereby keeping the developing roller 106 and the photosensitive drum 104 in a state of separation from each other (i.e., the drum-roller separation state). The problem of the developing roller 106 and the photosensitive drum 104 being in contact for a long time when not working may be alleviated.

Also, since the developing gear 32 no longer rotates, the photosensitive drum 104 may be driven to rotate by the charging roller 105 under the action of friction, and then drive the driving gear 33 to rotate. There may be interference between the driving gear 33 and the developing gear 32, that is, the teeth of the driving gear 33 may also apply a pushing force to the developing gear 32, and may apply a pushing force to the developing gear 32 together with the intermediate gear 142. In some embodiments, the pushing force may be applied to the developing gear 32 only by the driving gear 33, that is, the pushing force may not be applied to the developing gear 32 by the intermediate gear 142, and the intermediate gear 142 may be set to be non-engaged with the developing gear 32.

### Embodiment 9

In another embodiment, the structure may be approximately the same as in Embodiment 8, the main difference being that the charging roller gear 34 may not be provided, and the coupling 14 may be fixedly connected to the photosensitive drum 104 for transmitting the driving force from the drum drive transmission unit 203 to the photosensitive drum 104.

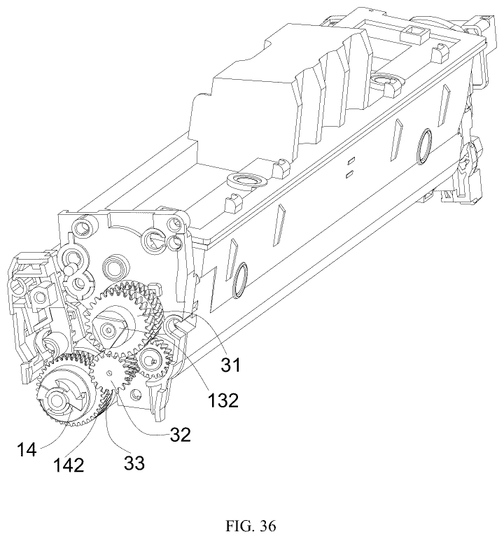

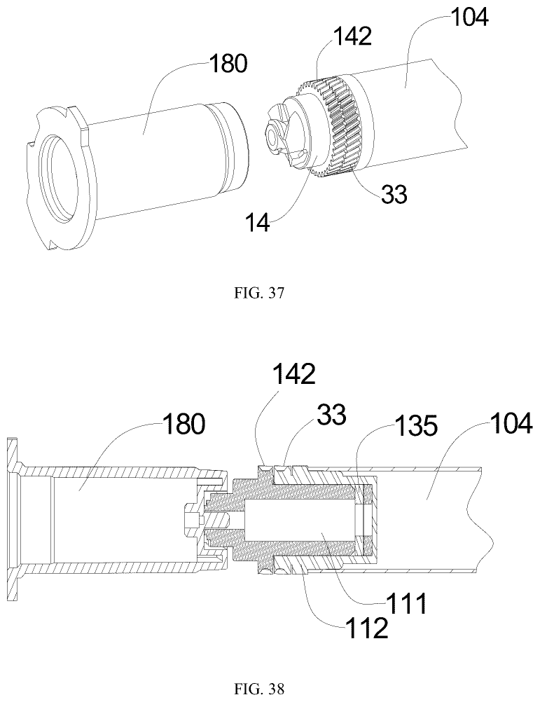

As shown in FIG. 36 to FIG. 38, the coupling 14 may include a sleeve 112 and a middle accommodation member 111 provided in the middle of the sleeve 112. The driving gear 33 may be coaxially fixed on the sleeve 112, and the sleeve 112 may be fixedly provided with the photosensitive drum 104. One end of the middle accommodation member 111 may be engaged with the driving force transmission member 180 of the drum drive transmission unit 203 to receive the driving force, and the other end of the middle accommodation member 111 may be fixedly connected to the sleeve 112, to be fixedly connected to the photosensitive drum 104. The sleeve 112 and the middle accommodation member 111 may be fixedly connected by a magnetic member 135, or may be fixedly connected by other means.

The driving gear 33 may mesh with the developing gear 32, such that the photosensitive drum 104 receives the driving force from the developing driving force transmission unit of the main assembly through the driving gear 33, the developing gear 32, the transmission gear 31 and the developing driving force receiving unit 132. In some embodiments, an intermediate gear 142 may be provided on the middle accommodation member 11, or may not be provided.

When performing the developing operation, the photosensitive drum 104 may receive the driving force of the developing driving force transmission unit through the driving gear 33 to rotate, and the coupling 14 may receive the driving force of the drum driving transmission unit 203 to rotate through the middle accommodation member 111. The photosensitive drum 104 and the coupling 14 may rotate consistently.

When the developing operation is completed, the developing driving force transmission unit may stop outputting the driving force, and the driving force transmitted to the developing driving force receiving unit 132 may disappear, such that the developing driving force receiving unit 132 stops rotating. Therefore, the developing gear 32 connected to the transmission gear 31 may also stop transmitting, and may no longer transmit power to the driving gear 33. While the drum drive transmission unit 203 may keep outputting the driving force, and the coupling 14 may still receive the driving force of the drum drive transmission unit 203. The coupling 14 may transmit the driving force to the photosensitive drum 104 through the magnetic member 135, driving the photosensitive drum 104 to rotate, thereby avoiding the situation where the photosensitive drum 104 loses the power of the developing driving force receiving unit 132 after the developing operation is completed and stops rotating which causes friction with the transfer belt and wear of the photosensitive drum 104.

### Embodiment 10

Another embodiment provides another processing cartridge. The structure in the present embodiment may be similar to Embodiment 8, the main difference is that the application method of the pushing force may be different.

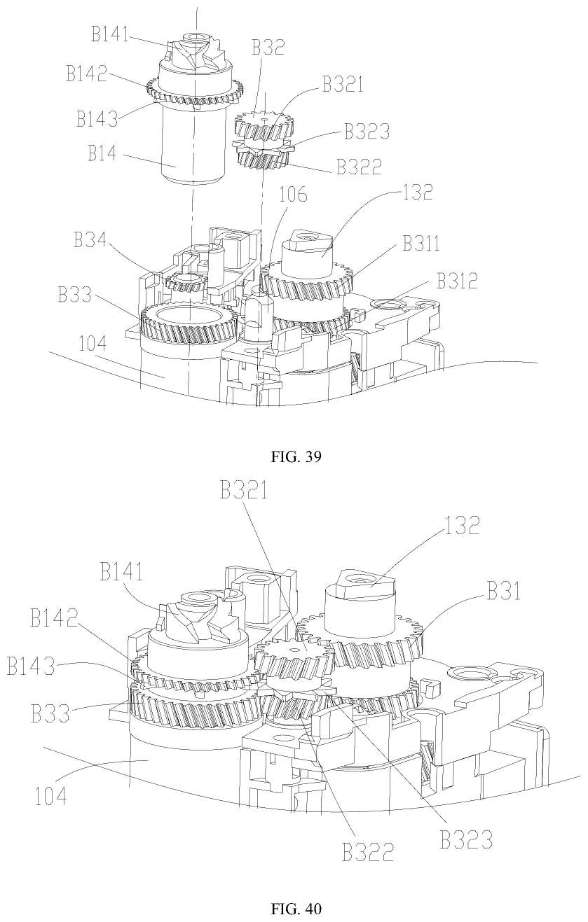

As shown in FIG. 39, in the present embodiment, the drum unit may further include a first special-shaped gear B143 which may be coaxially fixed with the coupling 14 (it may be manufactured in one piece or manufactured in separate pieces and then fixedly connected). The developing unit may further include a second special-shaped gear B323 which may be coaxially arranged with the developing gear 32 (it may be manufactured in one piece or in separate pieces and then fixedly connected). The developing gear B32 may include a primary gear B321, a secondary gear B322 and the second special-shaped gear B323, where the second special-shaped gear B323 may be located between the primary gear B321 and the secondary gear B322. The teeth of the first special-shaped gear B143 and/or the second special-shaped gear B323 may be provided with non-driving inclined surfaces, which are different from the involute tooth surfaces used by normal gears. The non-driving inclined surfaces may be difficult to transmit driving force, while may produce a slipping effect. When the teeth of the first special-shaped gear act on the teeth of the second special-shaped gear, the second special-shaped gear may not rotate normally, while may be pushed away by the first special-shaped gear. Compared with normal gears, this special-shaped gear may be more conducive to generating a pushing force. The non-driving inclined surface may be a plane or an arc surface, as long as it is able to make the second special-shaped gear be pushed away. Optionally, the teeth of the first special-shaped gear B143 and the second special-shaped gear B323 may be triangular in shape.

The meshing parts of the developing gear and the transmission gear in this embodiment may be set as helical teeth. The developing gear B32 and the second special-shaped gear B323 may be set to be able to move in the axial direction.

As shown in FIG. 40, when the processing cartridge performs the developing operation, the developing driving force receiving unit 132 may receive the driving force from the electronic imaging device and drive the developing gear B32 and the driving gear B33 to rotate, thereby driving the developing roller 106 and the photosensitive drum 104 to rotate. At this time, the coupling B14 may also be connected to the drum drive transmission unit 203, such that the intermediate gear B142 and the first special-shaped gear B143 also rotate accordingly. Since the developing driving force receiving unit 132 rotates clockwise after receiving the driving force, a force that makes the developing roller 106 move closer to the photosensitive drum 104 may be generated. Therefore, the photosensitive drum 104 and the developing drum 106 may be in a state of contact with each other (i.e., a drum-roller contact state), and at this time, the first special-shaped gear B143 and the second special-shaped gear B323 may be offset from each other, such that there may be no interference between the first special-shaped gear B143 and the second special-shaped gear B323 and the photosensitive drum 104 and the developing drum 106 may stably maintain the state of contact.

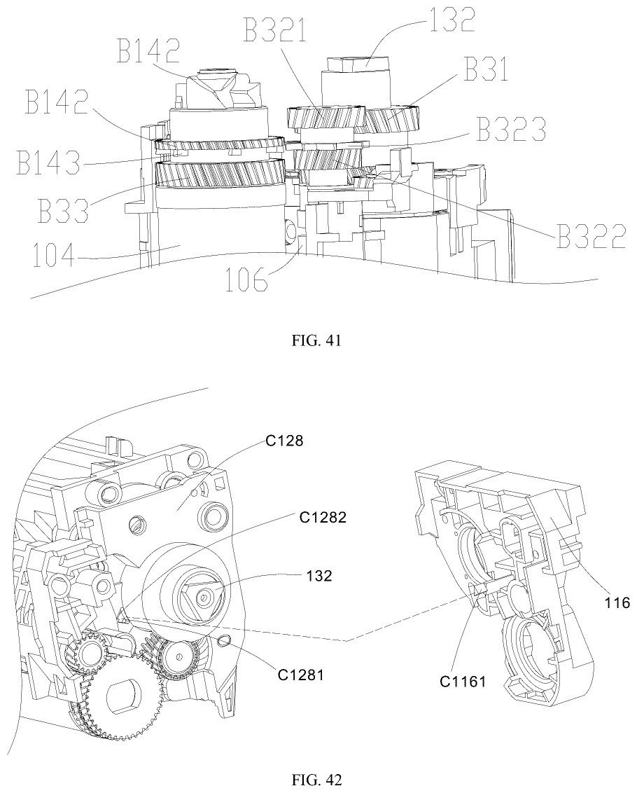

As shown in FIG. 41, when the developing operation is finished, the developing driving force transmission unit may stop outputting the driving force, and the driving force transmitted to the developing driving force receiving unit 132 may disappear, such that the developing driving force receiving unit 132 stops rotating and the transmission gear B31 stops rotating accordingly. Since the coupling B14 continues to rotate, the charging roller 105 may continue to rotate, and the photosensitive drum 104 may be driven to rotate by the charging roller 105 through the friction force, such that the driving gear B33 rotates accordingly. The developing gear B32 may be meshed with the driving gear B33, such that the developing gear B32 continues to rotate after the transmission gear B31 stops rotating. Therefore, the first-stage gear B321 of the developing gear B32 may move axially through the helical teeth between the first-stage gear B321 and the transmission gear B31 that stops rotating, and the second special-shaped gear B323 may also move to a position flush with the first special-shaped gear B143. At this time, since the coupling B14 may be still rotating, there may be interference between the rotating first special-shaped gear B143 and the second special-shaped gear B323, that is, the first special-shaped gear B143 may apply a pushing force to the second special-shaped gear B323, such that the second special-shaped gear B323 drives the developing roller 106 to move in the direction away from the photosensitive drum 104. Therefore, the developing unit 109 connected to the developing roller 106 may be also forced to rotate counterclockwise, such that the steel ball screw 60 located in the first positioning hole 1281 moves to the second positioning hole 1282, thereby keeping the developing roller 106 and the photosensitive drum 104 in a state of separation from each other (i.e., the drum-roller separation state), solving the problem of long-term contact between the developing roller 106 and the photosensitive drum 104 when not working.

### Embodiment 11

In another embodiment, the structure may be similar to Embodiment 8, the main difference is that the positioning protrusion is not a steel ball screw.

As shown in FIG. 42, a positioning protrusion C1161 may be provided on the driving side end cover 116, and a first positioning hole C1281 and a second positioning hole C1282 may be provided on the protective cover C128 at positions corresponding to the positioning protrusion C1161. The first positioning hole C1281 may be located below the second positioning hole C1282. The positioning protrusion C1161, the first positioning hole C1281 and the second positioning hole C1282 may adopt a triangular structure. The first positioning hole C1281 and the second positioning hole C1282 may be connected.

For example, when the processing cartridge performs the developing operation, the positioning protrusion C1161 may be located in the second positioning hole C1282, such that the developing roller 106 and the photosensitive drum 104 remain in contact with each other. When the processing cartridge stops developing, the intermediate gear 142 may apply a pushing force to the developing gear 32, such that the developing gear 32 drives the developing roller 106 to move away from the photosensitive drum 104. Therefore, the protective cover C128 connected to the developing roller 106 may also be forced to rotate counterclockwise, and the positioning protrusion C1161 may move to the first positioning hole C1281, thereby stably maintaining the developing roller 106 and the photosensitive drum 104 in a drum-roller separation state.

### Embodiment 12

In another embodiment, the structure may be similar to Embodiment 8, the main difference is that the photosensitive drum 104 may move upward and separate from the transfer belt when the processing cartridge is not performing the developing operation.

The present embodiment provides a processing cartridge of another structure. In this embodiment, the intermediate gear 142 and the charging roller gear 34 may not be set. When the processing cartridge is performing the developing operation, the charging roller 105 may not be driven to rotate by the coupling D14, but may be driven to rotate by the photosensitive drum 104 by friction. When the developing operation of the processing cartridge is completed, the charging roller 105 may stop rotating as the photosensitive drum 104 stops rotating. In other embodiments, the intermediate gear 142 and the charging roller gear 34 may be provided.

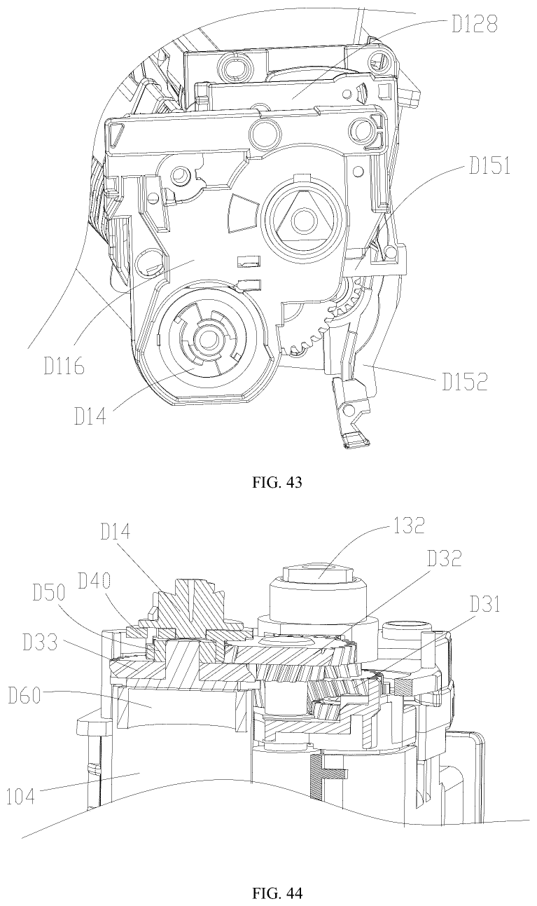

As shown in FIG. 43 and FIG. 44, the processing cartridge may further include a moving part D151, and the developing unit 109 may further include a separating part D152. The separating part D152 may be movably mounted on the protective cover D128 and may move and rotate in the direction of gravity. A connecting member D40, a supporting member D50 and a n may also be provided at one end of the photosensitive drum 104. There may be a gap between the coupling D14 and the connecting member D40 and the supporting member D50, and no transmission relationship may be formed, such that the coupling D14 is not able to transmit power to the photosensitive drum 104. The fixing member D60 may be fixedly arranged in the photosensitive drum 104, and the connecting member D40 and the supporting member D50 may be rotatably mounted on the fixing member D60, such that the connecting member D40 and the supporting member D50 are able to act on the photosensitive drum 104 through the fixing member D60 and drive the photosensitive drum 104 to move together in the G1 direction (roughly the up and down direction). The connecting member D40 and the supporting member D50 may not rotate with the fixing member D60, thereby avoiding affecting the rotational movement of the photosensitive drum 104. As shown in FIG. 44, the main body D51 of the supporting member D50 may be fixed by the clamping portion D41 of the connecting member D40, thereby preventing the supporting member D50 from being separated from the connecting member D40. When the supporting member D50 is subjected to an external force, it may drive the connecting member D40 to move together with the photosensitive drum 104 in the G1 direction.

Further, the driving gear D33 may be arranged between the connecting member D40 and the fixing member D60. The driving gear D33 may be coaxially fixedly mounted on the photosensitive drum 104 and mesh with the developing gear D32. The developing gear D32 may be a double-stage gear, and may mesh with the transmission gear D31. Since the transmission gear D31 is fixedly connected to the developing driving force receiving unit 132, the photosensitive drum 104 may receive the driving force from the developing driving force receiving unit 132 through the driving gear D33. That is, the driving force may be sequentially transmitted to the photosensitive drum 104 through the developing driving force receiving unit 132, the transmission gear D31, the developing gear D32 and the driving gear D33.

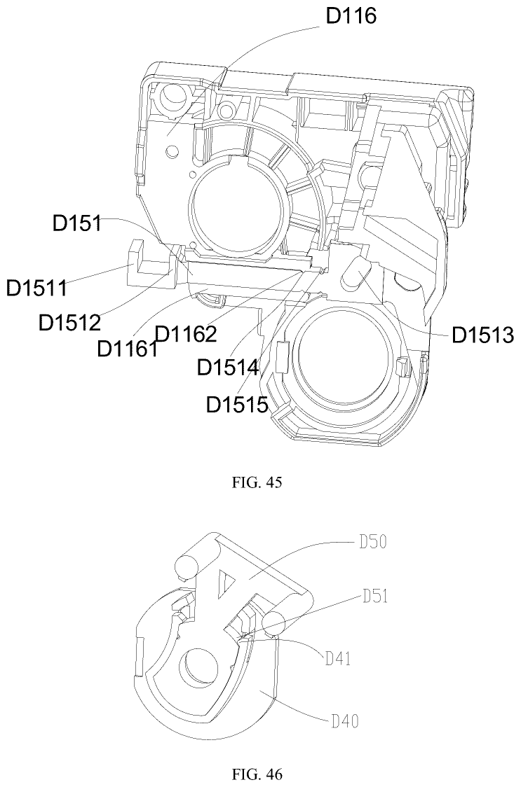

As shown in FIG. 45, the driving side end cover D116 may be provided with a slide groove D1161, and the slide groove D1161 may include a protrusion D1162. The moving member D151 may be a long rod-shaped structure. One end of the moving member D151 may be provided with a recessed portion, which may be formed by a first limiting portion D1511 and a second limiting portion D1512. Another end of the moving member D151 may be provided with a guide hole D1513, and a first recessed hole D1514 and a second recessed hole D1515 may also be disposed near the guide hole D1513. The protrusion D1162 may be located in the first recessed hole D1514 or the second recessed hole D1515, and the guide hole D1513 may be connected to the fixed column D52 of the supporting member D50, such that the moving member D151 may be installed on the processing cartridge. In some other embodiments, the moving member D151, the separating member D152, the connecting member D40, the supporting member D50 and the fixing member D60 may also be arranged at the non-driving end of the processing cartridge, or may be arranged at both the driving end and the non-driving end, or may be arranged only at the driving end or the non-driving end.

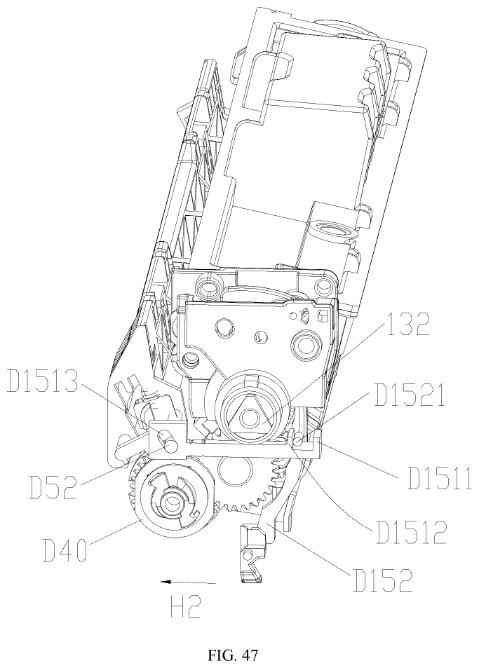

As shown in FIG. 47, when the processing cartridge performs the developing operation, the developing driving force receiving unit 132 may receive the driving force from the electronic imaging device and drive the developing gear D32 and the driving gear D33 to rotate, thereby driving the developing roller 106 and the photosensitive drum 104 to rotate. Currently, the coupling B14 may also be connected to the drum drive transmission unit 203. Since the developing driving force receiving unit 132 rotates clockwise after receiving the driving force, the separating member D152 may receive the contact force of the separating mechanism (not shown in the figure) of the electronic imaging device and move toward the H2 direction (roughly the horizontal direction), to drive the entire developing unit 109 to rotate clockwise, thereby generating a force that makes the developing roller 106 approach the photosensitive drum 104. Therefore, the photosensitive drum 104 and the developing drum 106 may be in a state of contact with each other (i.e., the drum roller contact state). The limiting protrusion D1521 of the separating member D152 may abut against the second limiting portion D1512, and the protrusion D1162 may be located in the first recessed hole D1514, such that the moving member D151 may remain in the horizontal position without moving and the fixed column D52 of the supporting member D50 remains in the lower position of the guide hole D1513. Therefore, the photosensitive drum 104 may maintain stable contact with the transfer belt.

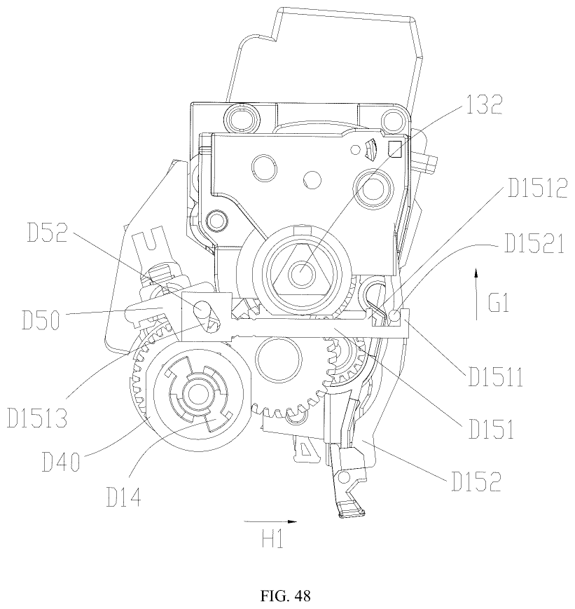

As shown in FIG. 48, when the developing operation is completed, the developing driving force transmission unit may stop outputting the driving force, and the driving force transmitted to the developing driving force receiving unit 132 may disappear. The developing driving force receiving unit 132 may stop rotating, and therefore the developing gear B32 connected to the transmission gear B31 may also stop rotating and may no longer transmit power to the driving gear B33. The photosensitive drum 104 may also stop rotating after losing power. To prevent the photosensitive drum 104 from being worn because of friction with the transfer belt after the photosensitive drum 104 loses the power of the developing driving force receiving unit and stops rotating after the developing operation is completed, the separating member D152 may be moved toward the H1 direction by the separating force of the separating mechanism (not shown in the figure), and the separating member D152 may rotate counterclockwise and move from the position abutting against the first limiting portion D1512 to the position abutting against the second limiting portion D1511, thereby driving the moving member D151 to move in the H1 direction (roughly horizontally). The fixed column D52 may move in the G1 direction (roughly vertically upward) under the action of the guide hole D1513, such that the supporting member D50 drives the connecting member D40 and the photosensitive drum 104 to move upward in the G1 direction, and finally the photosensitive drum 104 may move upward away from the transfer belt, thereby solving the problem that the photosensitive drum no longer rotates and contacts with the transfer belt for a long time when the processing cartridge stops developing. At this time, the second recessed hole D1515 may move to a position abutting against the protrusion D1162 with the horizontal movement of the moving member D151, such that the moving member D151 remains in the horizontal position without moving and the fixed column D52 of the supporting member D50 is maintained in the upper position of the guide hole D1513. Therefore, the photosensitive drum 104 may be maintained above the transfer belt.

When the processing cartridge needs to perform the development operation again, the separating member D152 may receive the contact force of the separation mechanism (not shown in the figure) of the electronic imaging device and move toward the H2 direction (roughly the horizontal direction), to drive the entire developing unit 109 to rotate clockwise, thereby generating a force that makes the developing roller 106 move toward the photosensitive drum 104. Therefore, the photosensitive drum 104 and the developing drum 106 may be in a state of contact with each other (i.e., the drum-roller contact state). Also, the moving member D151 may be driven by the separating member D152 to move toward the H2 direction (roughly the horizontal direction), and the fixed column D52 may move vertically downward under the action of the guide hole D1513. Therefore, the supporting member D50 may drive the connecting member D40 and the photosensitive drum 104 to move in the vertical downward direction, and finally make the photosensitive drum 104 contact the transfer belt downward to perform the developing operation. At this time, the limiting protrusion D1521 of the separating member D152 may abut against the second limiting portion D1512, and the first recessed hole D1514 may move to the position abutting against the protrusion D1162 with the horizontal movement of the moving member D151.

The embodiments disclosed herein are exemplary only. Other applications, advantages, alternations, modifications, or equivalents to the disclosed embodiments are obvious to those skilled in the art and are intended to be encompassed within the scope of the present disclosure. In some cases, the actions or steps recited in the present disclosure may be performed in an order different from that in the embodiments and still achieve desirable results. In addition, the processes depicted in the accompanying figures do not necessarily require the particular order shown, or sequential order, to achieve desirable results. Multitasking and parallel processing may be also possible or may be advantageous in certain embodiments.

Any process or method descriptions in flowcharts or otherwise described herein may be understood to represent modules, segments or portions of code comprising one or more executable instructions for implementing custom logical functions or steps of a process, and the scope of preferred embodiments of this specification includes alternative implementations in which functions may be performed out of the order shown or discussed, including in substantially simultaneous fashion or in reverse order depending on the functions involved.

In the present disclosure, the disclosed systems, devices or methods can be implemented in other ways. For example, the device embodiments described above are only illustrative. For example, the division of the units is only a logical function division. In actual implementation, there may be other division methods. For example, multiple units or components may be combined or may be integrated into another system, or some features may be ignored or not implemented. In another point, the mutual coupling or direct coupling or communication connection shown or discussed may be through some interfaces, and the indirect coupling or communication connection of devices or units may be in electrical, mechanical or other forms. Each functional unit in each embodiment of the present disclosure may be integrated into one processing unit, or each unit may exist separately physically, or two or more units may be integrated into one unit. The above-mentioned integrated units can be implemented in the form of hardware, or in the form of hardware plus software functional units.

The integrated units implemented in the form of software functional units may be stored in a non-transitory computer-readable storage medium. The above-mentioned software functional units may be stored in a storage medium, including several instructions to enable a computer device (which may be a personal computer, a connector, or a network device, etc.) or a processor to execute a portion of the methods described in each embodiment of the present disclosure. The aforementioned storage media may include medium that can store program code such as a flash disk, a mobile hard disk, read-only memory (ROM), random access memory (RAM), magnetic disk or optical disc, etc.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. A drum unit, comprising a photosensitive drum and a coupling, wherein:
the drum unit is used to be detachably installed in a main assembly of an image forming device;
the main assembly includes a drum drive transmission unit;
the drum drive transmission unit includes a driving force transmission member, a first braking force engagement member, and a second braking force engagement member, wherein the first braking force engagement member and the second braking force engagement member are disposed in the driving force transmission member;
the driving force transmission member includes a cylindrical part, a driving force transmission part and a positioning boss;
the coupling is coaxially disposed at one end of the photosensitive drum, and includes a middle accommodation member and a sleeve; and
the sleeve is provided with a driving force accommodation member, wherein the driving force accommodation member is able to be engaged with the driving force transmission member to transmit power received from the driving force transmission member to the photosensitive drum.

2. The drum unit according to claim 1, wherein:
the sleeve is sleeved outside the middle accommodation member;
the middle accommodation member and the sleeve are fixed in an axial direction and are rotatable in a circumferential direction;
the sleeve is fixed to the photosensitive drum; and
the middle accommodation member is engaged with the first braking force engaging member and/or the second braking force engaging member of the driving force transmission member, wherein the middle accommodation member does not transmit driving force to the photosensitive drum.

3. The drum unit according to claim 2, wherein:
the coupling further includes a fixing part fixed to one end of the middle accommodation member facing the photosensitive drum, and the fixing part abuts against one end of the sleeve facing the photosensitive drum;
matching steps are respectively provided on an outer wall of the middle accommodation member and an inner wall of the sleeve; and
the fixing part and the matching steps cooperate to fix the middle accommodation member axially relative to the sleeve.

4. The drum unit according to claim 2, wherein:
the driving force transmission part of the driving force transmission member is provided with an inclined surface; and
the driving force accommodation member is a power transmission part provided on the sleeve and protrudes in a direction away from the photosensitive drum, wherein the power transmission part is used to engage with the inclined surface to transmit the driving force to the photosensitive drum.

5. The drum unit according to claim 2, wherein:
the driving force accommodation member is an annular transmission part fixed to the sleeve, and the annular transmission part includes a friction surface that contacts with an end of the cylindrical part of the driving force transmission member and generates a friction force to transmit a driving force to the photosensitive drum through the friction force.

6. The drum unit according to claim 5, wherein:
the friction surface of the annular transmission part includes a first friction surface for contacting an outer circumferential surface of the cylindrical part and a second friction surface for contacting an end face of the cylindrical part; or
the annular transmission part is made of elastic material, and the annular transmission part is able to be deformed under a compressive force of the cylindrical part, thereby forming the first friction surface for contacting the outer circumferential surface of the cylindrical part and the second friction surface for contacting the end face of the cylindrical part.

7. The drum unit according to claim 1, wherein:
the coupling also includes an end accommodation member arranged at an end of the sleeve;
a guiding part and an engaging groove are provided on the end accommodation member; and
when the coupling is engaged with the driving force transmission member, the guiding part guides the first braking force engagement member and/or the second braking force engagement member into the engaging groove to form an engagement, wherein the end accommodation member does not transmit the driving force to the photosensitive drum.

8. A drum unit, comprising a photosensitive drum and a coupling, wherein:
the drum unit is used to be detachably installed in a main assembly of an image forming device;
the main assembly includes a drum drive transmission unit;
the drum drive transmission unit includes a driving force transmission member, a first braking force engagement member, and a second braking force engagement member, wherein the first braking force engagement member and the second braking force engagement member are disposed in the driving force transmission member;
the driving force transmission member includes a cylindrical part, a driving force transmission part and a positioning boss;
the coupling is coaxially arranged at one end of the photosensitive drum; and
the coupling includes a middle accommodation member; wherein the middle accommodation member is able to be engaged with the driving force transmission member to transmit power received from the driving force transmission member to the photosensitive drum.

9. The drum unit according to claim 8, wherein:
the middle accommodation member is fixedly connected to the photosensitive drum, and is provided with a receiving part for inserting the positioning boss of the driving force transmission member;
the receiving part includes a friction end face that contacts with an inner abutment surface of the driving force transmission member and generates a friction force and/or a friction side wall that contacts with an outer circumferential surface of the positioning boss and generates a friction force, to transmit the driving force to the photosensitive drum through the friction force.

10. The drum unit according to claim 8, wherein:
the middle accommodation member includes a guiding part and a locking groove;
when the coupling is engaged with the driving force transmission member, the guiding part guides the first braking force engagement member and/or the second braking force engagement member into the locking groove to form an engagement; and
the first braking force engagement member and/or the second braking force engagement member form a transmission with the locking groove, or the first braking force engagement member and/or the second braking force engagement member are axially fixed with the locking groove and are able to move circumferentially in the locking groove.

11. A processing cartridge used to be detachably installed in a main assembly of an image forming device, comprising the drum unit according to claim 1.

12. A processing cartridge used to be detachably installed in a main assembly of an image forming device, comprising a developing unit, a drum unit, and a coupling, wherein:
the main assembly includes a drum drive transmission unit and a developing driving transmission unit;
the drum drive transmission unit includes a driving force transmission member, a first braking force engagement member, and a second braking force engagement member, wherein the first braking force engagement member and the second braking force engagement member are disposed in the driving force transmission member;
the developing unit includes a developing frame, a developing roller, and a developing driving force receiving unit;
the drum unit includes a photosensitive frame and a photosensitive drum;
the coupling is coaxially arranged at an end of the photosensitive drum;
the coupling is able to be engaged with the drum drive transmission unit to receive a driving force; and
the developing driving force receiving unit is used to engage with the developing driving force transmission unit to receive a driving force, to drive the developing roller and the photosensitive drum to rotate.

13. The processing cartridge according to claim 12, wherein:
the developing unit further includes a transmission gear and a developing gear, wherein the transmission gear is coaxially fixed with the developing driving force receiving unit, the developing gear is coaxially fixed with the developing roller, and the transmission gear is meshed with the developing gear;
the drum unit further includes a driving gear coaxially fixed with the photosensitive drum;
the coupling is rotatably arranged at one end of the photosensitive drum; and
the driving gear is able to be meshed with the developing gear, such that the photosensitive drum obtains the driving force from the developing driving force transmission unit.

14. The processing cartridge according to claim 13, wherein:
the drum unit also includes a charging roller and a charging roller gear rotatably arranged on the photosensitive frame, wherein the charging roller and the charging roller gear are coaxially fixed;
the drum unit also includes an intermediate gear, wherein the intermediate gear is coaxially fixed with the coupling;
the intermediate gear is meshed with the charging roller gear; and
when the developing driving force transmission unit stops outputting the driving force and the drum drive transmission unit keeps outputting the driving force, the charging roller obtains the driving force from the drum drive transmission unit through the charging roller gear, the intermediate gear and the coupling, such that the photosensitive drum is driven to rotate by the surface friction with the charging roller.

15. The processing cartridge according to claim 14, wherein:
when the developing driving force transmission unit stops outputting the driving force and the drum driving transmission unit keeps outputting the driving force, the driving gear rotates with the photosensitive drum and applies a pushing force to the developing gear, such that the developing gear drives the developing roller to move away from the photosensitive drum, and the developing roller separates from the photosensitive drum.

16. The processing cartridge according to claim 14, wherein:
the developing gear is configured to mesh with the intermediate gear; and
when the developing driving force transmission unit stops outputting the driving force and the drum driving transmission unit keeps outputting the driving force, the intermediate gear rotates with the coupling and applies a pushing force to the developing gear, such that the developing gear drives the developing roller to move away from the photosensitive drum, and the developing roller is separated from the photosensitive drum.

17. The processing cartridge according to claim 14, wherein:
the drum unit further includes a first special-shaped gear coaxially fixed with the coupling;
the developing unit further comprises a second special-shaped gear coaxially fixed with the developing gear;
the developing gear and the second special-shaped gear are arranged to be movable in the axial direction;
teeth of the first special-shaped gear and/or teeth of the second special-shaped gear are provided with non-driving inclined surfaces, such that a pushing force is generated when they are engaged;
a meshing part of the developing gear and the transmission gear is provided with helical teeth;
when the developing driving force transmission unit stops outputting the driving force and the drum driving transmission unit keeps outputting the driving force, the driving gear rotates with the photosensitive drum to drive the developing gear to rotate, and the helical teeth of the developing gear act on the helical teeth of the transmission gear, such that the developing gear moves in the axial direction, the second special-shaped gear moves in the axial direction from a position misaligned with the first special-shaped gear to a position engaged with the first special-shaped gear, the first special-shaped gear rotates with the coupling and applies a pushing force to the second special-shaped gear, such that the second special-shaped gear drives the developing roller to move in the direction away from the photosensitive drum, and the developing roller is separated from the photosensitive drum.

18. The processing cartridge according to claim 13, wherein:
the developing unit also includes a separating member which is movably connected to the developing frame and is able to receive a separation force and/or a contact force of a separation mechanism of the main assembly and move;
the processing cartridge also includes a moving member which is respectively connected to the separating member and the photosensitive drum;
when the separating member receives the contact force, the moving member is driven by the separating member to drive the photosensitive drum to move downward and contact a transfer belt; and
when the separating member receives the separation force, the moving member is driven by the separating member to drive the photosensitive drum to move upward and separate from the transfer belt.

19. The processing cartridge according to claim 18, further including an end cover arranged at an end of the developing unit and the drum unit, wherein:
the moving member is arranged on the end cover and is able to move in the horizontal direction;
a first end of the moving member interacts with the separating member, such that the moving member moves in the horizontal direction under the action of the separating member and the contact force; and
a second end of the moving member interacts with the photosensitive drum to convert the horizontal movement of the moving member into an up-down movement of the photosensitive drum.

20. The processing cartridge according to claim 19, wherein:
the separating member is provided with a limiting protrusion, and the first end of the moving member is provided with a recess, wherein the limiting protrusion is arranged in the recess and is able to drive the recess to move in the horizontal direction;
the drum unit also includes a supporting member, and the supporting member is connected to the photosensitive drum, and a fixing column is arranged on the supporting member; and
the second end of the moving member is provided with a guide hole, and the fixing column is arranged in the guide hole and is able to be displaced in the vertical direction with the horizontal movement of the guide hole to drive the photosensitive drum to move up and down.
